(19) United States
(12) Patent Application Publication
(10) Pub. No.: US 2012/0150707 A1
(43) Pub. Date: Jun. 14, 2012

(54) SYSTEMS AND METHODS FOR PROVIDING ENERGY EFFICIENT BUILDING EQUIPMENT AND SERVICES

(75) Inventors: Iain Campbell, Milwaukee, WI (US); Kirk H. Drees, Cedarburg, WI (US); Derek Supple, Milwaukee, WI (US)

(73) Assignee: Johnson Controls Technology Company

(21) Appl. No.: 13/236,489

(22) Filed: Sep. 19, 2011

Related U.S. Application Data
(60) Provisional application No. 61/384,582, filed on Sep. 20, 2010.

(51) Int. Cl. G06Q 40/06; G06Q 50/06; G06Q 30/04

(52) U.S. Cl. 705/34

(57) ABSTRACT

A system for providing energy and/or water efficient building improvements to a building owned by a building owner is shown and described. The system includes a computer system configured to generate an invoice for the building owner based on estimated utilities that would have been consumed by the building had the building improvement measures not been installed. The computer system causes payment to an entity financing the building equipment using a portion of the difference between the invoiced estimated baseline utility consumption and the actual utility consumption costs.

### CROSS REFERENCE TO RELATED APPLICATIONS

This application claims the benefit of U.S. Provisional Application No. 61/384,582, filed Sep. 20, 2010, the entirety of which is incorporated by reference.

### BACKGROUND

In many areas of the country electrical generation and transmission assets have or are reaching full capacity. One of the most cost effective ways to ensure reliable power delivery is to reduce demand (MW) by improving energy efficiency. Because commercial buildings consume a substantial portion of the generated electricity in the United States, a major strategy for solving energy grid problems is to implement energy efficiency measures within commercial buildings. Further, companies are working to reduce their utility costs by implementing facility improvement measures within buildings.

In existing buildings, replacing energy inefficient building equipment and control systems with energy efficient building equipment and control systems is the primary strategy for reducing a building's energy consumption and associated costs. Other strategies include improving the operation of existing systems by retro-commissioning, schedule changes, control sequence changes, and improved building operational practices. Despite stable and attractive financial returns provided by such energy conservation measures, building owners can be slow to implement capital intensive retrofit projects.

### SUMMARY

One embodiment of the invention relates to a system for managing costs associated with energy efficient building improvements provided to a building owned by a building owner. The system includes a building management system in communication with building equipment installed at the building. The building management system is configured to use inputs from the building equipment to estimate energy that would have been consumed by the building had the building improvement measures not been installed. The system further includes a computer system configured to receive a representation of the estimated energy consumption from the building management system. The computer system is configured to receive a representation of actual energy consumption costs from an energy provider for the building. The computer system is configured to generate an invoice for the building owner based on the estimated energy that would have been consumed by the building had the building improvement measures not been installed. The computer system causes payment to an entity financing the building improvement measures using a portion of the difference between the invoiced estimated energy consumption and the actual energy consumption costs.

Another embodiment relates to a method for providing energy efficient building improvement measures to a building owned by a building owner. The method includes using inputs from building equipment and other sources to estimate energy that would have been consumed by the building had the building improvement measures not been installed. The method further includes generating an invoice for the building owner based on the estimated energy that would have been consumed by the building had the building improvement measures not been installed. The method also includes receiving a representation of actual energy consumption costs from an energy provider of the building. The method yet further includes causing payment to an entity financing the building improvement measures using a portion of the difference between the invoiced energy consumption and the actual energy consumption costs.

Another embodiment relates to a method for providing energy efficient building improvement measures to a building owned by a building owner. The method includes purchasing the building improvement measures, agreeing to pay the building owner for access to the building, and agreeing to pay an energy services company for installation of the building improvement measures and for ongoing services relating to the building improvement measures. The method also includes receiving an invoice for actual energy consumption by the building from an energy provider. The method further includes receiving data from the building equipment and using the data to generate an invoice based on an estimated energy that would have been consumed by the building had the building improvement measures not been installed. The method also includes causing payment to an entity financing the building improvement measures using a portion of the difference between the invoiced estimated energy consumption and the actual energy consumption costs. The method may include using a building management system in communication with the building equipment to calculate the estimated energy that would have been consumed by the building had the building improvement measures not been installed. The building management system may calculate the estimated energy by applying inputs from the building equipment and other sources to at least one energy consumption model for the building. The energy consumption model is a model of how the building consumed energy prior to installation of the building improvement measures. In some embodiments, the building management system does not use historical energy costs or historical energy consumption alone to estimate the energy that would have been consumed by the building had the building improvement measures not been installed. However, in some embodiments, the building management system may use historical energy consumption to build the at least one energy consumption model. Embodiments of the method may include causing payment of service fees to an energy services company that provides services relating to the building improvement measures. The building improvement measures may be provided to the building (or tenant) as a part of a service contract (e.g., between an ownership company and the building owner or tenant). In an exemplary embodiment, the building improvement measures are not owned by the building owner. The ownership company may pay the invoice for the actual energy consumption as an agent of the building owner. The method may also include causing payment to an energy services company using another portion of the difference between the invoiced estimated energy consumption and the actual energy consumption costs.

Another embodiment relates to computer readable media having computer code instructions for execution by a processor. The computer code instructions are for managing costs associated with energy efficient building improvement measures provided to a building owned by a building owner. The computer code instructions include computer code for receiving an invoice for actual energy consumption by the building from an energy provider. The computer code instructions include computer code for receiving data from the building equipment and using the data to generate an invoice based on an estimated energy that would have been consumed by the building had the building improvement measures had not been installed. The computer code instructions further include computer code for causing payment to an entity financing the building improvement measures using a portion of the difference between the invoiced estimated energy consumption and the actual energy consumption costs.

Alternative exemplary embodiments relate to other features and combinations of features as may be generally recited in the claims.

### BRIEF DESCRIPTION OF FIGURES

The disclosure will become more fully understood from the following detailed description, taken in conjunction with the accompanying figures, wherein like reference numerals refer to like elements, in which:

The block diagram of FIG. 1A illustrates a system 100 for providing energy efficiency improvements to a building 102 owned by a building owner (or building tenant), according to an exemplary embodiment.

The block diagram of FIG. 1B illustrates the ownership company's (OwCo's) computer system for invoicing and payments, according to an exemplary embodiment.

FIG. 2A illustrates an exemplary flow chart of a process for managing costs associated with providing energy efficient building improvements to a building, according to an exemplary embodiment.

FIG. 2B illustrates an exemplary invoice that may be generated by the computer system of the ownership company and provided to a building owner or tenant. The invoice requires the building owner or tenant to pay for an estimated utility consumption (e.g., energy demand, energy consumption, energy demand and consumption, water consumption, etc.) based on the energy that the building would have consumed had the energy efficient building improvements not been installed.

FIG. 2C illustrates an exemplary graphical user interface for showing supporting data that may be provided with the invoice of FIG. 2B and/or shown on a graphical user interface with the invoice. The illustration of FIG. 2C may help explain the baseline model used to calculate the invoice.

FIG. 2D illustrates another exemplary graphical user interface for showing supporting data that may be provided with the invoice of FIG. 2B and/or shown on a graphical user interface with the invoice. The illustration of FIG. 2D may help explain the baseline model used to calculate the invoice.

FIG. 3 is a simplified illustration of the contractual relationships between the entities of the building owner and the OwCo and between the OwCo and the energy services company (ESCO).

FIG. 4 is a block diagram of an alternative system for providing energy or water efficiency improvements to a building, according to an exemplary embodiment.

FIG. 5 is a block diagram of another alternative system for providing energy efficiency building improvement measures is shown, according to an exemplary embodiment.

FIG. 6 illustrates that a plurality of buildings associated with a single enterprise may be the subject of the described systems and methods, according to some embodiments.

FIG. 7 illustrates a building management system (BMS) enterprise server for the plurality of BMSs of the plurality of buildings calculating energy savings or pre-retrofit energy estimations for the plurality of buildings, according to an exemplary embodiment.

FIG. 8A is a flow chart of a process for measuring and verifying energy savings and peak demand reductions in a building, according to an exemplary embodiment.

FIG. 8B is a simplified block diagram of a system for completing or facilitating the process of FIG. 8A, according to an exemplary embodiment.

FIG. 8C is a block diagram of a system for measuring and verifying energy savings in a building is shown, according to an exemplary embodiment.

FIG. 9 is a detailed block diagram of the baseline calculation module of FIG. 1C, according to an exemplary embodiment.

FIG. 10A is a flow chart of a process for selecting observed variable data to use for generation of the baseline model, according to an exemplary embodiment.

FIG. 10B is a flow chart of a process for selecting calculated variable data to use for generation of the baseline model, according to an exemplary embodiment.

FIGS. 11A-11E are more detailed flow charts of the process of FIG. 3B, according to an exemplary embodiment.

FIG. 12 is a flow chart of the objective function used in the golden section search of the process of FIGS. 11A-E shown in greater detail, according to an exemplary embodiment.

FIG. 13 is a flow chart of a process of calculating enthalpy, according to an exemplary embodiment.

### DETAILED DESCRIPTION

The present disclosure relates to technology-enabled models for financing energy efficient building equipment and services. Energy efficient building equipment and services can include renewable energy equipment and services (e.g., solar, wind, etc.) in addition to other energy saving control systems or devices (e.g., energy efficient HVAC devices, energy efficient lighting, etc.).

In an exemplary embodiment, a special purpose ownership entity (OwCo) is established to purchase energy efficient building equipment and services. The OwCo pays an access fee to the building owner (or tenant of a larger building) for use of the building under an agency managed efficiency services agreement (AMESA). The OwCo contracts with an energy services company (ESCO) to provide retrofit services, a guarantee of energy usage savings to be generated, operations and maintenance (O&M) services, and measurement & verification (M&V) services.

The ESCO sells the building equipment to the OwCo, retrofits the building with the building equipment, and guarantees energy usage savings. The OwCo owns the upgraded building equipment. The OwCo acts as an agent of the building owner in receiving actual utility bills from an energy provider (e.g., utility) and paying the actual utility bills. The OwCo does not invoice the building owner for the actual utility bills. Rather, the OwCo generates an invoice for the building owner based on an estimated energy that would have been consumed by the building had the new building improvement measures not been installed. In other words, the building owner's periodic (e.g., monthly, quarterly, etc.) payment to the OwCo for the term of the contract is the modeled pre-retrofit adjusted baseline energy usage for the period multiplied by the total active variable rate for utilities (e.g., the actual utility rate during the period). The building owner's payment to the OwCo can also include any fixed line items on the utility bill and a planned maintenance service fee.

The building owner does not need to expend the capital for the improved building equipment and can even achieve a discount with respect to its pre-retrofit energy costs (e.g., due to the annual access fee from the OwCo). The building owner also benefits from infrastructure renewal, an improved building environment, O&M cost savings, building labeling or certification value, enhanced brand attractiveness, and/or an enhanced property value.

While energy consumption and energy usage are primarily discussed (e.g., with reference to the estimations, M&V activities, payments, etc.), in some embodiments demand-based estimations and billings may be utilized. Such demand-based estimations and billings may be used in conjunction with consumption based-estimations and billings to arrive at an invoice for sending to the building owner based on energy actually consumed and/or demanded. Furthermore, in varying embodiments, demand may be substituted for consumption and still considered within the scope of the present disclosure.

The block diagram of FIG. 1A illustrates a system 100 for providing energy efficiency building improvements to a building 102 owned by a building owner (or building tenant), according to an exemplary embodiment. The primary entities of the system 100 include a building owner 102 (shown in the Figure for ease of illustration as one in the same as the building itself), an OwCo 104, an ESCO 106, an energy provider (e.g., one or more utility companies) 108, and debt or equity investors 110. It should be noted that energy efficiency or energy efficient building improvements may refer to efficient water use or building improvements that help to conserve or otherwise improve the building's use of water. In other words, rather than energy consumption, some embodiments of the present disclosure may relate to any utility consumption or a blend of different utility consumptions.

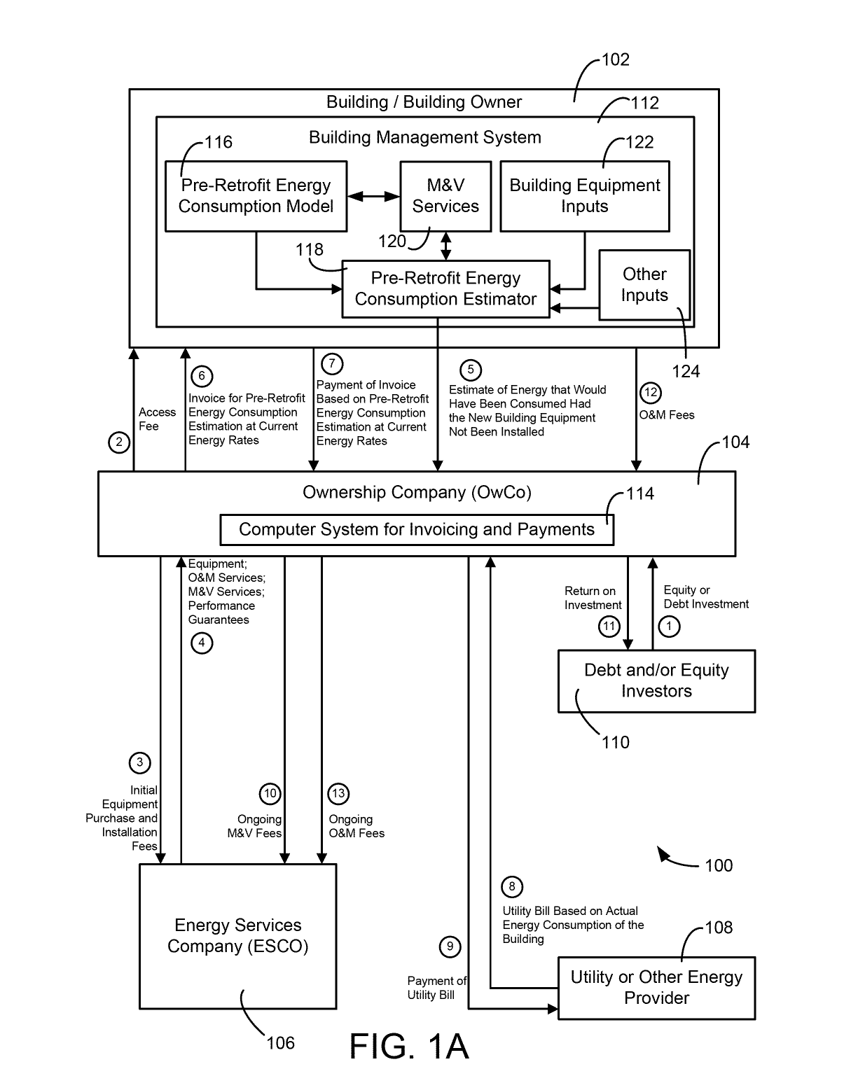

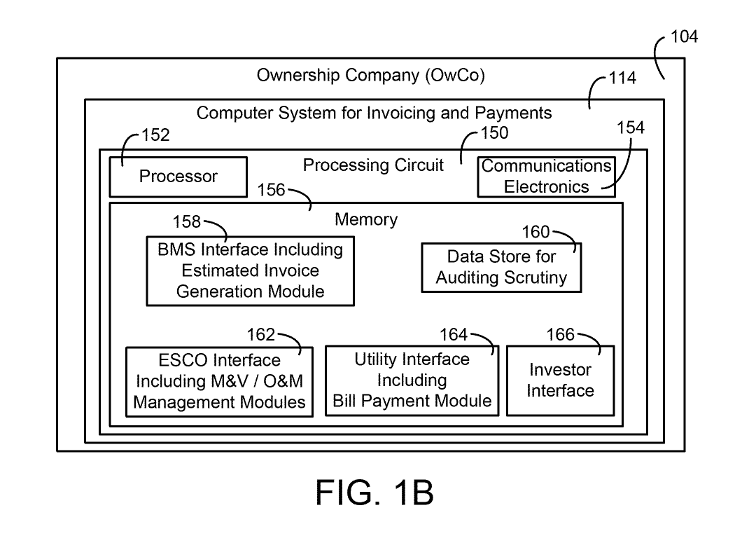

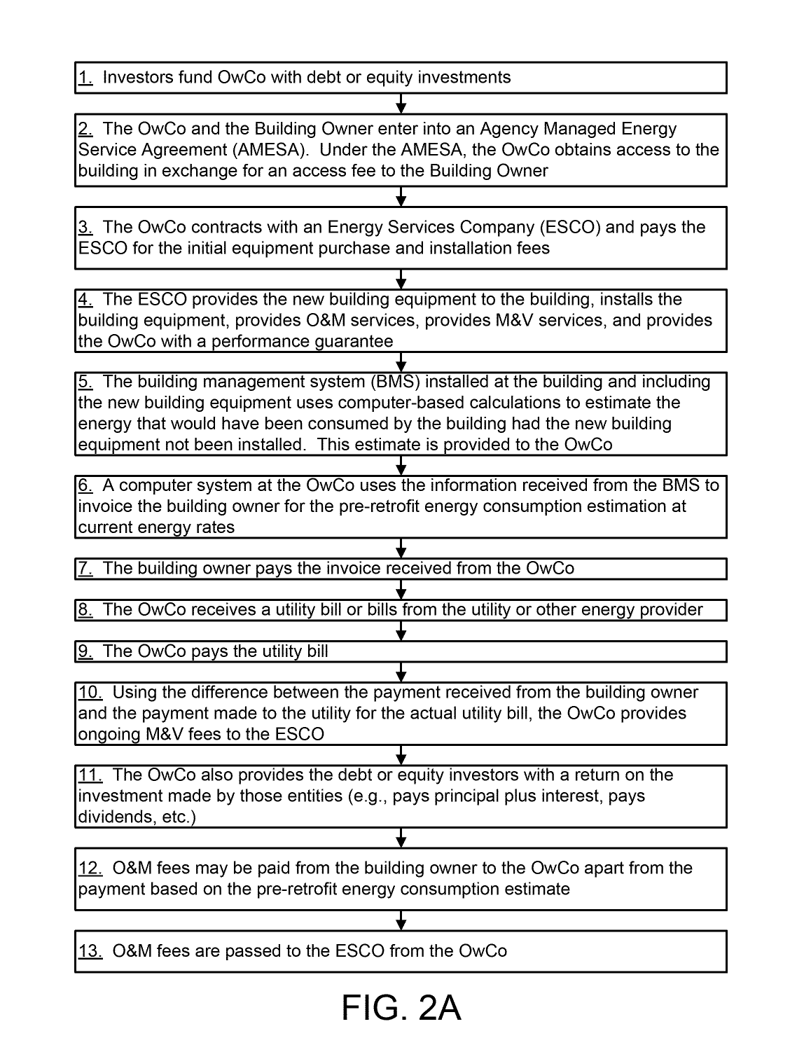

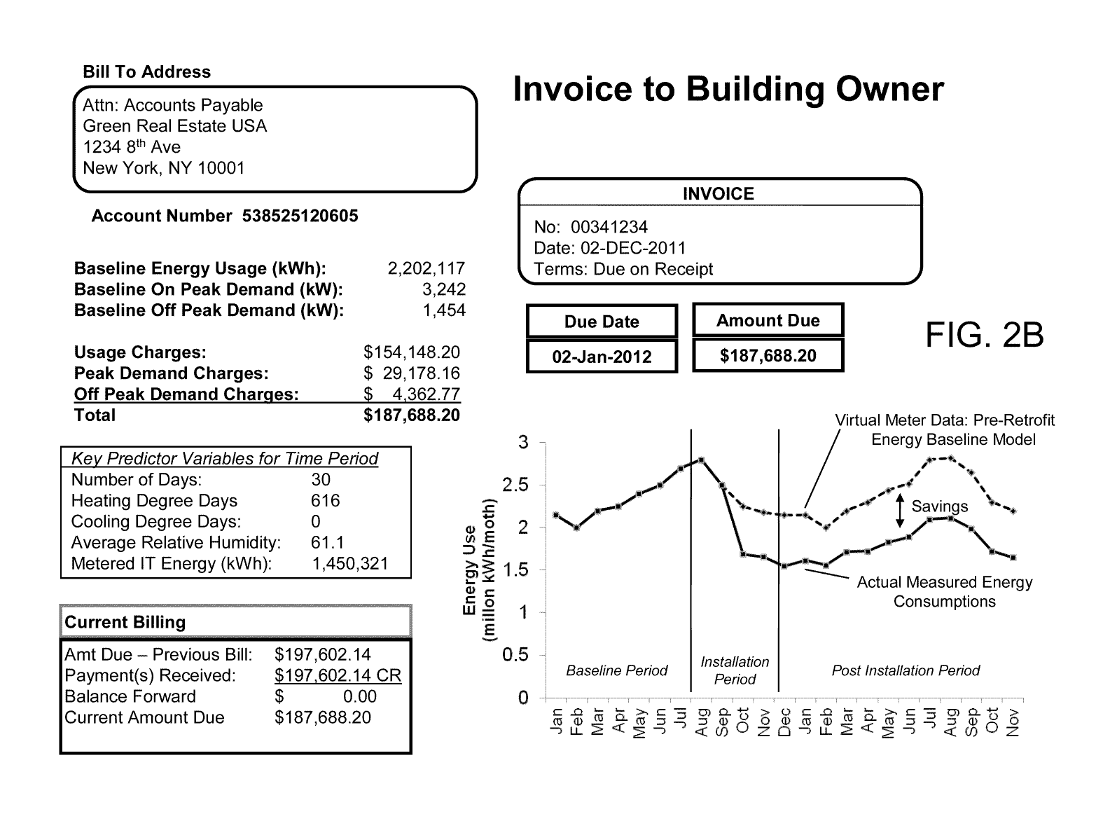

FIG. 2A illustrates an exemplary flow chart of a process for providing energy efficiency building improvements, according to an exemplary embodiment. The numbered steps of FIG. 2A correspond with the numbered transactions, communications or obligations illustrated in FIG. 1A. The process begins with debt and/or equity investors 110 funding the OwCo 104 (step 1). The OwCo 104 and the building owner 102 enter into an AMESA (e.g., service agreement, service contract, etc.) (step 2). Under the AMESA, the OwCo 104 obtains access to the building in exchange for an access fee paid to the building owner 102. In alternative embodiments, an access fee is not necessary or paid to the building owner 102. In such embodiments, for example, the building owner 102 may simply grant permission to the OwCo 104 and its agents as a part of an O&M contract or otherwise.

Referring still to FIGS. 1A and 2A, the OwCo 104 contracts with the ESCO 106 and pays the ESCO 106 for the initial equipment purchase and installation fees (step 3).

The ESCO 106 provides the new building equipment for the building, installs the building improvement measures (e.g., conducts energy efficient retrofitting of building equipment, conducts reconfiguration of existing equipment to improve energy efficiency), and provides the OwCo with a performance guarantee (step 4). The performance guarantee may be a contractual guarantee of the energy usage savings to be generated over the contract term.

A building management system (BMS) 112 installed at the building 102 and including the new building equipment uses computer-based calculations to estimate the energy that would have been consumed during a period of time, had the new building improvement measures not been installed (step 5). The calculated estimate is provided to the OwCo (e.g., via communications electronics, via an Internet link, via an automated e-mail, via graphical user interfaces provided to the OwCo, via a web-browser accessible dashboard, via XML data, via computerized reports, etc.).

A computer system 114 (e.g., of the OwCo, managed by the ESCO for the OwCo) for completing invoicing and payment steps generates an invoice based on the pre-retrofit energy consumption estimation at current energy rates (step 6). This invoice is provided to the building owner 102 and paid regardless of actual energy consumption (step 7). The utility bill based on actual energy consumption is provided from the utility or other energy provider to the OwCo 104 (step 8). The utility bill is paid by the OwCo 104 as an agent of the building owner 102 (step 9). Using the difference between the invoice paid by the building owner 102 and the actual utility bill payment, the OwCo 104 pays the ESCO 106 ongoing M&V fees (step 10) and provides a return on investment to the debt and/or equity investors (step 11). Independent from the payment based on the pre-retrofit energy consumption estimation, the building owner may agree to pay ongoing O&M fees to the OwCo 104 (step 12). These fees may be passed on to the ESCO 106 or other maintenance service providers in their entirety or in part (step 13).

Referring still to FIG. 1A and also to FIG. 1B, the OwCo 104 is shown to use a computer system 114 for invoicing and payments. The computer system 114 of the OwCo 104 can be implemented as a single computer or server. In other embodiments, the computer system 114 of the OwCo 104 can be implemented as a distributed system. In an exemplary embodiment, the computer system 114 of the OwCo 104 is configured to facilitate the communications and process steps shown in FIGS. 1A and 2A for a plurality of contracted building owners.

The computer system 114 of the OwCo 104 can include one or more processing circuits 150 for completing the communications steps and processing activities described herein and associated with the OwCo 104. The one or more processing circuits 150 of the computer system 114 can include a processor 152, a memory device 156, and communications electronics 154. The processor 152 can be implemented as a general purpose processor, an application specific integrated circuit (ASIC), one or more field programmable gate arrays (FPGAs), a group of processing components, or other suitable electronic processing components.

The memory device 156 (e.g., memory, memory unit, storage device, etc.) can be one or more devices (e.g., RAM, ROM, Flash memory, hard disk storage, etc.) for storing data and/or computer code for completing and/or facilitating the various processes described herein and associated with the OwCo 104. The memory 156 can also include computer code for supporting computations or controls (e.g., coordination of activities of communications electronics). The memory device 156 may be or include volatile memory or non-volatile memory. The memory device 156 may include database components, object code components, script components, or any other type of information structure for supporting the various activities and information structures described in the present disclosure. According to an exemplary embodiment, the memory device 156 is communicably connected to the processor 152 via the processing circuit 150 and includes computer code for executing one or more processes described herein.

The communications electronics 154 of the OwCo can include wired or wireless interfaces (e.g., jacks, antennas, transmitters, receivers, transceivers, wire terminals, etc.) for conducting data communications with, e.g., a smart grid, the utility or other energy provider, the BMS 112, accounting systems of the building owner, computer systems of the ESCO 106, or other electronics systems. The communications electronics 154 may effect such data communications via a direct connection or a network connection (e.g., an Internet connection, a LAN, WAN, or WLAN connection, etc.). For example, the communications electronics 154 can include an Ethernet card and port for sending and receiving data via an Ethernet-based communications link or network. In another example, the communications electronics 154 can include a WiFi transceiver for communicating via a wireless communications network.

In the illustration of FIG. 1B, memory 156 includes a BMS interface 158 including an estimated invoice generation module. The BMS interface 158 is configured to supervise communications with the BMS 112. For example, the BMS interface 158 may be passed information detected to be from the BMS 112, and the BMS interface 158 may parse such received information. Parsing such received information may include receiving, identifying, and storing the estimate (and any supporting data) of the energy that would have been consumed had the new building improvement measures not been installed. The BMS interface 158 may further be configured to gather pertinent utility information (e.g., from the utility interface, from a table in memory, etc.) and apply the utility information to the estimate of energy that would have been consumed. Using such a calculation (e.g., estimate of energy that would have been consumed during a period*utility rate), BMS interface 158 may generate an invoice for sending to the building/building owner 102. In an exemplary embodiment, the BMS interface 158 may format the invoice for consumption by the BMS 112 of the building 102. In other embodiments, the BMS interface 158 may format the invoice for consumption by an accounting, electronic billing, or other business system of the building or building owner.

Referring still to the illustration of FIG. 1B, memory 156 includes an ESCO interface 162. The ESCO interface 162 is shown to include M&V and O&M management modules. The M&V and O&M management modules may be web services or other data services configured to allow the ESCO and the OwCo to communicate regarding M&V and O&M tasks and data. For example, an OwCo may communicate changes in a service schedule or service obligation relating to a building or building owner to an ESCO. In response to such changes, the ESCO may be caused to update its service schedule or service obligation. The ESCO interface 162 may also facilitate O&M and M&V billing between the ESCO and the OwCo. In an exemplary embodiment, the ESCO interface 162 may use received M&V information (e.g., received from the M&V services of the BMS) to determine whether the ESCO is meeting its performance guarantee. The ESCO interface 162 may be configured with performance-based payment thresholds such that performance that does not meet the guarantee results in lower M&V or O&M fees while performance that exceeds the guarantee is paid in full or paid a bonus. In an exemplary embodiment, the ESCO interface 162 may communicate payment information to a bank for electronically or manually sending payment to the ESCO 106.

Referring further to the illustration of FIG. 1B, memory 156 includes a utility interface 164 including a bill payment module. Utility interface 164 may be configured to electronically receive and store a utility bill based on actual energy consumption of the building from a utility or other energy provider 108. The utility interface 164, for example, may receive electronic utility bill information (e.g., in the form of a parsable PDF, a parsable XML file, in the form of synchronous data communication messages), parse the utility bill information, store the utility bill information, and act upon the utility bill information. The utility interface 164 may pay the utility bill on behalf of the building or building owner 102. When a utility bill is paid on behalf of the building owner, the utility interface 164 may inform the building owner of the payment. The utility interface 164 may store the utility bill information for use in evaluating the performance guarantee of the ESCO, for use in BMS interface 158's invoice generation, or otherwise. The utility interface 164 may also forward the utility information (e.g., information about how much energy was actually consumed during a period) so that the M&V services of the BMS 112 can determine whether a baseline model used by the M&V process has changed. Using such a determination, the pre-retrofit energy consumption estimator 118 may be able to be updated to provide a better estimate of the energy that would have been consumed had the new building improvement measures not been installed.

Referring still to the illustration of FIG. 1B, memory 156 includes an investor interface 166. The investor interface 166 is configured to provide a portal for reporting cash flow, returns on investment, or other values and information to debt and/or equity investors. The investor interface 166 can be or include a collection of web pages and scripts configured to recall investor accounts and to provide account information to the investors via the communications electronics 154.

In the embodiment shown in FIG. 1B, memory 156 is also shown to include a data store for auditing scrutiny 160. The data store for auditing scrutiny 160 may operate to store data provided by M&V services. For example, the data store for auditing scrutiny 160 may store actual energy consumption parameters, historical pre-retrofit energy consumption model data, a calculated confidence level associated with the pre-retrofit energy consumption, and other M&V data. The data store for auditing scrutiny 160 may also store O&M information, M&V fee information, utility bill histories, and the like.

The building management system 112 of FIG. 1A is shown to include a pre-retrofit energy consumption model 116, M&V services 120, building equipment inputs 122, and other inputs 124. The pre-retrofit energy consumption model 116 may be stored in a memory device of the building management system 112 and is specific to its related building environment, usage, and pre-retrofit equipment. In some embodiments, the building management system 112 is distributed among one or more computers. Accordingly, the memory device for the pre-retrofit energy consumption model 116, its inputs, and the M&V services 120 may be stored within a remotely located server (e.g., hosted server) of the building management system 112. The pre-retrofit energy consumption model (i.e., baseline model) 116 may be calculated as described in detail below (in the section titled “Pre-Retrofit Energy Consumption Model and Related Measurement and Verification Services”) by the M&V services 120. Using the pre-retrofit energy consumption model 116 calculated by the M&V services 120, the pre-retrofit energy consumption estimator 118 may determine the energy that would have been consumed (e.g., a blend of consumption and/or demand) had the energy efficient improvements not been made. The M&V services 120 may be configured to calculate the pre-retrofit energy consumption model 116 as described in the M&V section of this document listed below.

The building equipment inputs 122 can be or include data signals from building equipment (e.g., sensors, actuators, field controllers, supervisory controllers, data from building equipment and stored in one or more databases, etc.). Other inputs 124 can include linked, live, or other database information used to estimate pre-retrofit energy consumption. For example, other inputs 124 can include weather information received from weather services or Internet resources, production levels of a factory or other plant, occupancy levels of an office building, or other inputs that may be used to predict energy expenditure.

FIG. 2B illustrates an exemplary invoice that may be generated by the computer system of the ownership company and provided to a building owner or tenant. The invoice requires the building owner or tenant to pay for an estimated utility consumption (e.g., energy demand, energy consumption, energy demand and consumption, water consumption, etc.) based on the energy that the building would have consumed had the energy efficient building improvements not been installed. In the invoice of FIG. 2B, a graph of virtual meter data (built using a pre-retrofit energy baseline model) is shown relative to actual measured energy consumption. The difference between the two equals energy savings in the post installation period. Despite this energy savings, the invoice bills the building owner for the virtual meter energy usage or the baseline energy usage (consumption+demand charges) estimated using the pre-retrofit energy baseline model. The OwCo then passes on the savings (e.g., the difference between what is billed to the building owner and the actual utility costs) to the investor. The invoice of FIG. 2B is shown to include details of baseline energy usage (in kWh), baseline on peak demand (kW), and baseline off peak demand (kW). Each of these three metrics are estimated using the pre-retrofit energy baseline model and, together, represent the energy that would have been consumed had the energy efficient building improvements not been installed. Charges are calculated using the three baseline-calculated energy consumption metrics. Predictor variables used to estimate the energy consumption by applying the variables to the model are shown. The invoice of FIG. 2B may be sent electronically and/or printed out and mailed to the building owner or building tenant. The computer system of the OwCo may provide the property owner or tenant with on-demand internet access to view the amount of estimated baseline energy and actual consumption for the most recent time intervals as well as historical trends over time.

FIG. 2C illustrates an exemplary graphical user interface for showing supporting data that may be provided with the invoice of FIG. 2B and/or shown on a graphical user interface with the invoice. The illustration of FIG. 2C may help explain the baseline model used to calculate the invoice. The graph of FIG. 2C may show the building owner or tenant that while the maximum outdoor air temperature and humidity vary, the weekly power consumption does not change much relative to the average.

FIG. 2D illustrates an exemplary graphical user interface for showing supporting data that may be provided with the invoice of FIG. 2B and/or shown on a graphical user interface with the invoice. The illustration of FIG. 2D may help explain the baseline model used to calculate the invoice. The graph of FIG. 2D may show the building owner or tenant how weekly inspected instantaneous total UPS load (in kW) for building devices UB1-UB5 can be used as predictor variables for estimating weekly whole facility electrical consumption (in kWh/week) and the result of a regression analysis relating the two variables. The computer system of the OwCo may provide FIG. 2C and FIG. 2D to the property owner or tenant so that the property owner or tenant can view and understand calculation methodologies, results of regression analyses, and time series data used to create a pre-retrofit energy consumption model and/or to estimate energy consumption using the model. Such graphical outputs are intended to provide the property owner or tenant with transparency to all calculations provided by the system. The OwCo system and/or the building management system may also be configured to export detailed time-series data for all model inputs and outputs for the purpose of providing the data transparency to the users.

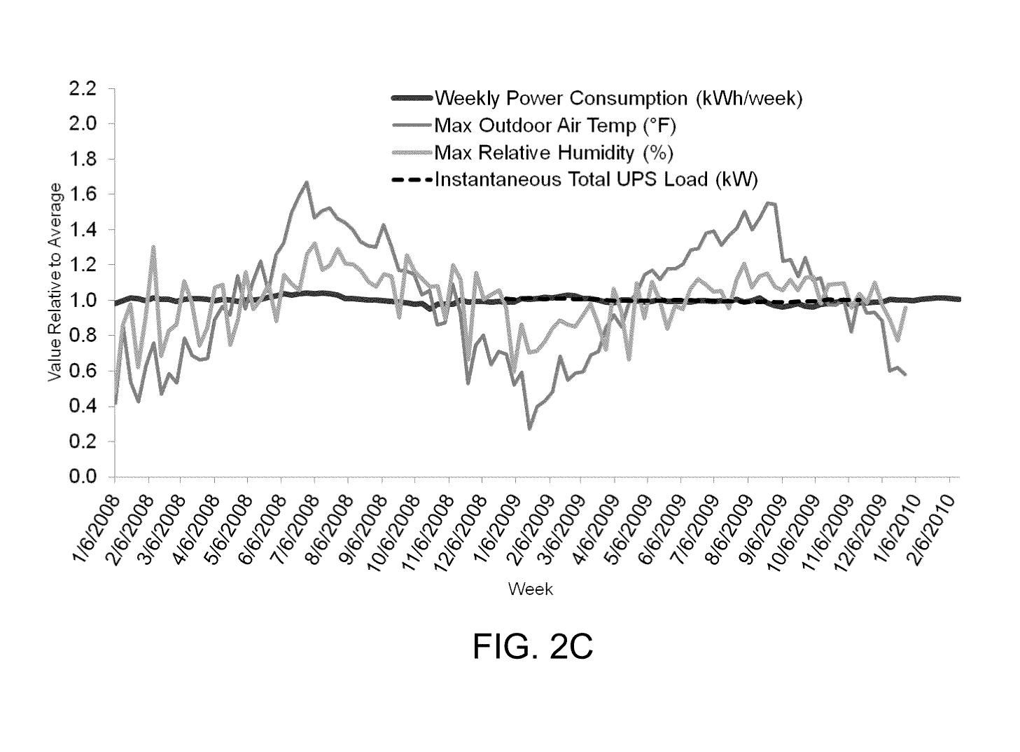

FIG. 3 is a simplified illustration of the contractual relationships between the entities of the building owner 102 and the OwCo 104 and between the OwCo 104 and the ESCO 106. A services agreement (e.g., an AMESA) is put into place between the building owner 102 and the OwCo 104. The services agreement provides the OwCo 104 with the right to use a building (or group of buildings, part of a building, a floor, a suite, a facility, a campus, a portfolio of properties, etc.) to generate verified energy usage savings (negawatt-hours) and to retain the savings (i.e., monetizable benefits) of the negawatt-hours. A ground lease or utility easement included within the services agreement or in addition to the services agreement may provide for the OwCo 104's access and maintenance rights on the building owner's property. The building owner 102 benefits under the services agreement by being provided with facility upgrades that improve the building environment and reduce energy usage, water usage, and building lifecycle costs. The services agreement also assigns the OwCo 104 the obligation or right to pay utility bills as an agent on behalf of the building owner 102. Thereafter, the OwCo 104 serves as an intermediary or agent between the building owner and utilities or energy providers. The services agreement specifies that the building owner 102 will pay a monthly service fee to the OwCo 104 for the term of the agreement (e.g., 5 years, 10 years, etc.). The service fee may include an amount equal to an estimated energy usage (e.g., based on a stored baseline model for the building) multiplied by an active variable rate (e.g., $/kWh) for the energy usage. The services agreement may also provide for payment of any fixed cost line items billed by the utility and a planned maintenance service fee (i.e., O&M fee).

Because the OwCo 104 pays the actual utility bills for the property on an agency basis, the OwCo 104 retains the value equal to the volumetric energy savings at current variable utility rates (less fees paid to the ESCO 106 such as M&V fees, O&M fees, etc.). While the benefit to the OwCo 104 may be strictly financial (building owner payments minus actual utility costs), in other embodiments the OwCo 104 also retains any negotiable ownership rights for environmental attributes of financial value generated by the project (e.g., energy efficiency credits or certificates (EEGs), renewable energy credits (RECs), verified emission reductions (VERs), etc.). In order for the OwCo 104 to generate a return for the equity or debt investors, the volumetric utility energy savings generated by the building improvements over the contract term (e.g., as guaranteed by the ESCO 106 in the performance contract described below) must exceed the building improvement measures purchase costs and/or installation costs, the M&V service fees, and the access fee paid to the building owner. In an exemplary embodiment, the O&M fee is not covered by the energy cost savings earned by the OwCo 104, but is rather passed-through to the building owner. In another exemplary embodiment, the O&M fee is covered by the energy cost savings earned by the OwCo 104. Under the services agreement, the building owner benefits from the annual facility access fee from the OwCo, any O&M savings (e.g., any discount relative to the building owner's previous O&M costs), from a renewed building infrastructure or indoor environment, and from the enhanced brand and/or enhanced marketing value of building labeling or certification (e.g., Energy Star, LEED, NABERS, Green Globes, etc.).

In some exemplary embodiments, the purchase agreement, performance contract, and services agreement (i.e., “planned services agreement”) are established between the OwCo 104 and the ESCO 106. Under the performance contract, the ESCO 106 is obligated to retrofit the property and to guarantee certain energy savings. The retrofit activities may include building equipment retrofit services including, but not limited to, energy audits, detailed design and engineering, business case analysis, installation, commissioning, and performance measurement & verification. A purchase agreement may generally provide for the transfer of the building equipment from the ESCO 106 to the OwCo 104. The services agreement (i.e., “planned services agreement”) may provide for ongoing operations and maintenance by the ESCO 106 in exchange for fees that are not dependent on energy savings performance. In varying exemplary embodiments, the agreements between the OwCo 104 and the ESCO 106 can be combined or bundled.

In the performance contract or in another agreement, the ESCO 106 and the OwCo 104 may agree on an M&V protocol to calculate the realized energy savings. Reconciliation may occur on an annual basis, quarterly basis, monthly basis, or on some other schedule. Consequences for energy savings shortfalls may be set forth in the performance contract. For example, if an annual energy savings shortfall occurs for any one year of the performance contract term, the ESCO 106 may be obligated to (a) set off the amount of such shortfall against any unpaid balance the OwCo 104 then owes to the ESCO 106, (b) pay the OwCo 104 the amount of such shortfall, or (c) provide to the OwCo 104 or the building owner 102 additional products or services equal in value to the shortfall. In an exemplary embodiment, the performance contract and service contract between the OwCo 104 and the ESCO 106 have the same term as the services agreement between the OwCo 104 and the building owner 102. In other embodiments, the multiple contracts of the systems and methods described herein may have different or varying terms. One or more of the contracts may terminate once a certain dollar amount has been earned by the OwCo 104 and/or paid out by the building owner 102.

The subject building property may be owner-occupied or tenant-occupied commercial real estate, lease real estate, lease real estate under a triple-net lease arrangement, or another type of building property. The property use may be office use, warehouse use, industrial use, commercial use, mixed use, academic, state-owned, or any other type of property. The building or property owner credit rating may vary. The OwCo's 104 access fee may be adjusted to account for varying building owner credit risks. In other exemplary embodiments, the O&M fees, M&V fees, or other fees from the building owner to the OwCo 104 may be scaled or adjusted to account for property owner credit risk.

The ESCO 106 may be a building controls and services contractor such as Johnson Controls, Inc. The ESCO 106 may develop a package of facility improvements for the subject building including, but not limited to, lighting upgrades, HVAC upgrades, building automation improvements, plumbing improvements, insulation improvements, irrigation system upgrades, energy information management software upgrades, and installation of on-site energy generation or storage systems (e.g., solar, wind, ground-source heat pumps, ice storage, etc.).

The building management system 112 includes a pre-retrofit energy consumption estimator 118 (a “virtual meter”) configured to continuously or periodically estimate what the building property's energy consumption would have been for a given period (monthly, weekly, or hourly) in the absence of the building/facility improvement implemented by the ESCO 106. This calculation may be automated. As described in greater detail below, the “virtual meter” computes an adjusted baseline energy consumption using a baseline energy consumption model for the building pre-retrofit. The baseline energy consumption model is generated using statistical regression relative to a plurality of statistically significant independent variables such as outdoor air temperature, humidity, enthalpy, utility bill period length, occupancy, building schedule, season, IT equipment energy consumption, units of factory production, days of the week, or others. The M&V process compares actual energy consumption data (e.g., actual meter data, utility company data, etc.) to the adjusted baseline energy consumption to calculate savings. The M&V process may adhere to the International Performance Measurement and Verification Protocol (IPMVP) or other M&V protocols. The M&V process or protocol may be agreed to by the building owner as a part of the services agreement with the OwCo 104.

The access fee paid from the OwCo 104 to the building owner 102 for use of the building (e.g., for a ground lease or utility easement) to generate energy savings creates a positive stream of income for the building owner 102 at the outset of the services agreement with the OwCo 104. In some embodiments, the access fee may be considered or structured as a leasehold interest in a real estate improvement. The access fee may be monthly, quarterly, yearly, or scheduled on some other interval or basis (e.g., paid up front). In an exemplary embodiment, the access fee would be fixed over the term of the services contract. For example, the annual access fee might be set to be equal to ten percent of the estimated energy cost savings expected to be achieved in the initial year of the performance contract. In other exemplary embodiments, the access fee may be variable with changing pre-retrofit energy consumption estimations (e.g., ten percent of the pre-retrofit energy consumption estimation for any given previous month). The access fee may be adjusted for major utility rate changes or major energy usage baseline adjustments (e.g., due to a change in the property's hours of operation, occupancy level, occupant behavior, building space use, etc.).

The below terms describe features of certain exemplary embodiments.

Equipment title: The OwCo 104 may retain ownership of the building equipment installed and maintain a first priority security interest in the building equipment (and/or other facility improvements).

Maintenance: ESCO 106 or its assignees may be required to maintain the equipment for the duration of the services agreement.

Insurance: The building equipment owned by the OwCo 104 may be added to the property owner's existing insurance policy and the OwCo 104 entity may be added as an additional named insured under the policy.

Accounting treatment: A goal of the systems and methods described herein may be to enable the building owner 102 to treat the facility upgrade and services arrangement with the OwCo 104 as a service agreement rather than as a long-term liability.

End of Term: Upon the end of the services agreement, the building owner 102 may renew the services agreement for continued efficiency services or purchase the energy efficient building improvement measures from the OwCo 104 at a predetermined or negotiated value (e.g., fair market value in the secondary market).

Completion Delay Risk: The completion delay risk may be borne by the ESCO 106. This risk may be contingent on physical access and cooperation by the building owner 102. The ESCO 106 may agree to provide damages equal to OwCo 104 debt service amounts if there are delays during construction/installation.

Cost Over-Run Risk: The cost over-run risk may be borne by the ESCO 106. The ESCO 106 may quote a gross maximum price intended to protect OwCo 104 lenders from cost overruns.

Cost Savings Performance Risk: The cost savings performance risk may be borne by the ESCO 106 via a performance contract between the OwCo 104 and the ESCO 106.

Energy Usage Risk: Because the baseline energy estimation is based on actual conditions (e.g., hours of operation, use, temperature, times, component levels of energy consumption, etc.) applied to a baseline energy consumption model, the building owners bears the energy usage risk.

Utility Price Change Risk: The utility price change risk may be borne by the OwCo 104. As utility prices rise, the OwCo 104 benefits from increased levels of monetary savings that result from the guaranteed volumetric utility usage savings. If utility prices fall, the OwCo 104 may derive losses from the decreased levels of monetary savings resulting from the retrofit project.

Building Owner Non-Payment Risk: Under a non-payment scenario, the OwCo 104 would provide notice to the building owner 102 of the outstanding obligation. The OwCo 104 would also provide notice of its intent to withhold its access fee and that the building equipment may be subject to deactivation, seizure, and/or removal if payment is not rendered within a cure period following the notice. If the planned O&M service fee is not paid by the building owner and passed through to the ESCO 106 by the OwCo 104, maintenance services from the ESCO 106 would stop and the ESCO 106's energy usage savings guarantee under the Performance Contract would be removed.

Building Owner Default: The risk of building owner default would be borne by the OwCo 104.

Building Owner Sale: Upon the prospect of sale or closure of the property by the building owner 102, the OwCo 104 would retain the right to review the proposed purchaser of the Property and could assign the services agreement to the property buyer for the remainder of the agreement term. Alternatively, the old or new building owner may negotiate a buyout at a price negotiated with the OwCo 104 (e.g. the undiscounted value of the remaining estimated service fee payments plus the service payments for one or more “penalty” years).

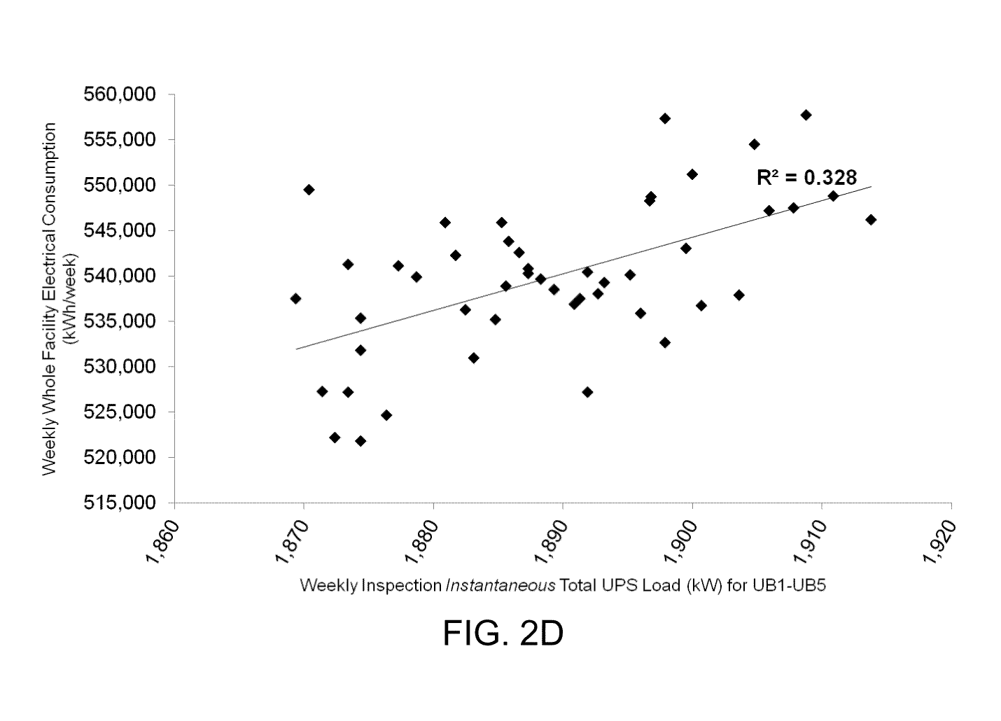

Referring now to FIG. 4, a block diagram of an alternative system for providing energy efficient building improvements and services to a building 402 is shown, according to an alternative exemplary embodiment. In the embodiment shown in FIG. 4, the M&V logic resides within a computer system of the ESCO 408. The computer system of the ESCO 408 receives raw or aggregated BMS data from the building's BMS 404. For example, the ESCO's computer system may receive BMS data for the past month pertinent to the inputs for the pre-retrofit energy consumption model 410. The pre-retrofit energy consumption estimator 414 may apply the received data to generate the pre-retrofit energy consumption model 410. The computer system of the ESCO 408 may further include a savings calculator 416 configured to compute the energy savings over a period of time. The invoices and payments shown above and described with respect to FIGS. 1A, 1B, and 2A are not shown in FIG. 4 but may remain the same regardless of BMS data flow and energy estimate calculation location. The computer system of the ESCO 408 may include one or more processing circuits for executing computer code modules. The M&V services 412, pre-retrofit energy consumption estimator 414, and the savings calculator 416 may be computer code modules stored in memory of the ESCO's computer system and configured for execution by a processing circuit or processor of the ESCO's computer system. Communications electronics of the ESCO's computer system can be caused to provide the energy savings information to the OwCo 406 (e.g., for use in invoicing, payment, calculation, etc.).

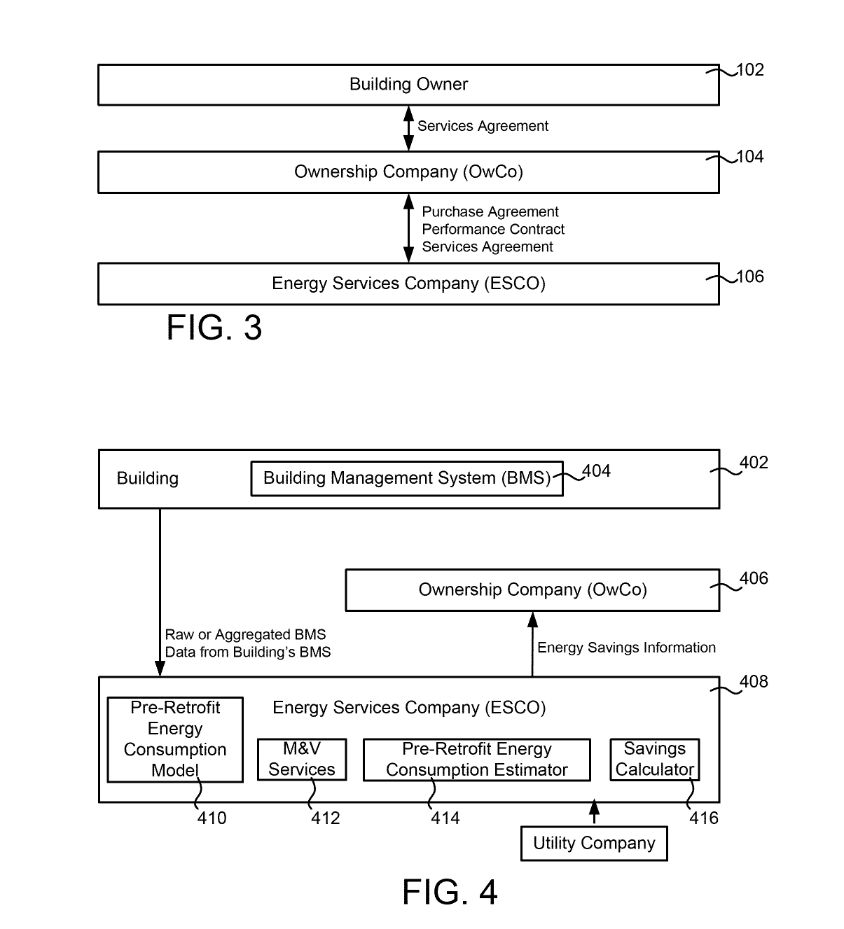

Referring now to FIG. 5, a block diagram of another alternative system for providing energy efficient building improvements and services is shown, according to an exemplary embodiment. In the system of FIG. 5, the M&V logic resides within a computer system of the OwCo 506. The computer system of the OwCo 506 receives raw or aggregated BMS data from the building 502's BMS 504. The computer system of the OwCo 506 may include one or more processing circuits for executing computer code modules (e.g., the blocks 508-514 shown in FIG. 5). The invoices and payments shown above and described with respect to FIGS. 1A, 1B, and 2 are not shown in FIG. 5 but may remain the same regardless of BMS data flow and energy estimate calculation location. For example, while not shown in FIG. 5, the OwCo 506 may still include the computer system for invoicing and payments and the OwCo 506 may continue sending invoices to the building owner based on pre-retrofit energy estimations.

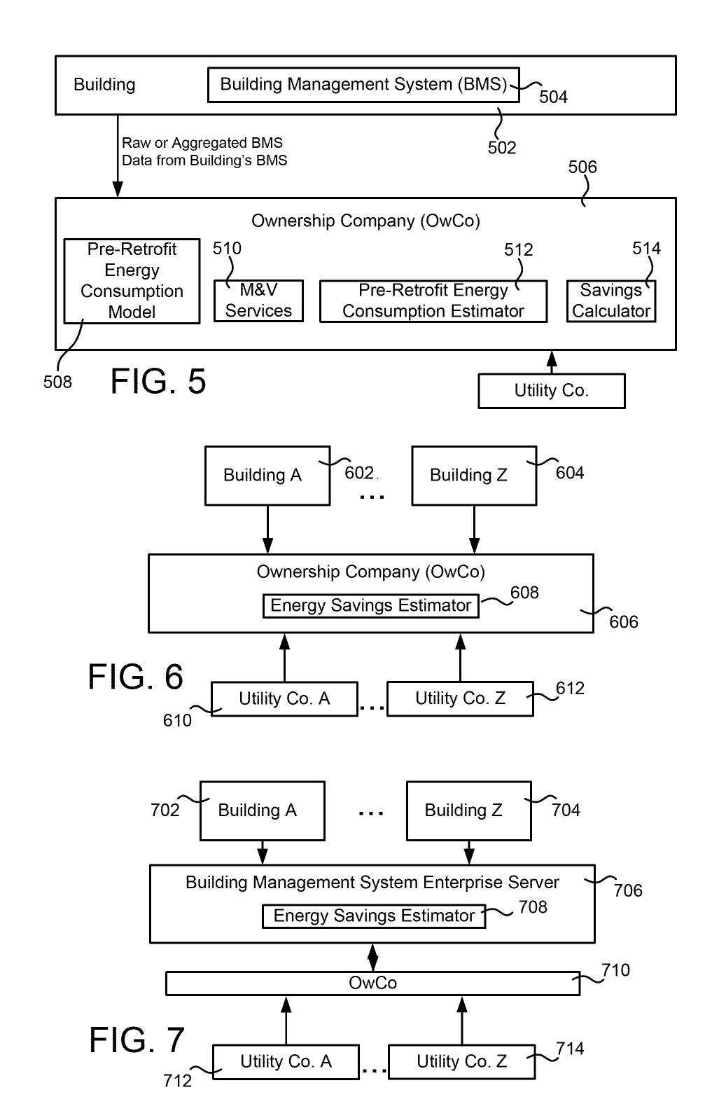

In the illustration of FIG. 6, a plurality of buildings 602,604 associated with a single enterprise may be the subject of the described systems and methods. Building data from BMSs of the plurality of buildings 602,604 is provided to an OwCo 606 computer system including an energy savings estimator 608. The energy savings estimator 608 can utilize stored baseline models for each of the plurality of buildings in calculating the pre-retrofit energy estimations. The computer system of the OwCo 606 can also track and utilize utility bill or actual usage information from a plurality of utility companies 610,612 associated with the plurality of buildings 602,604.

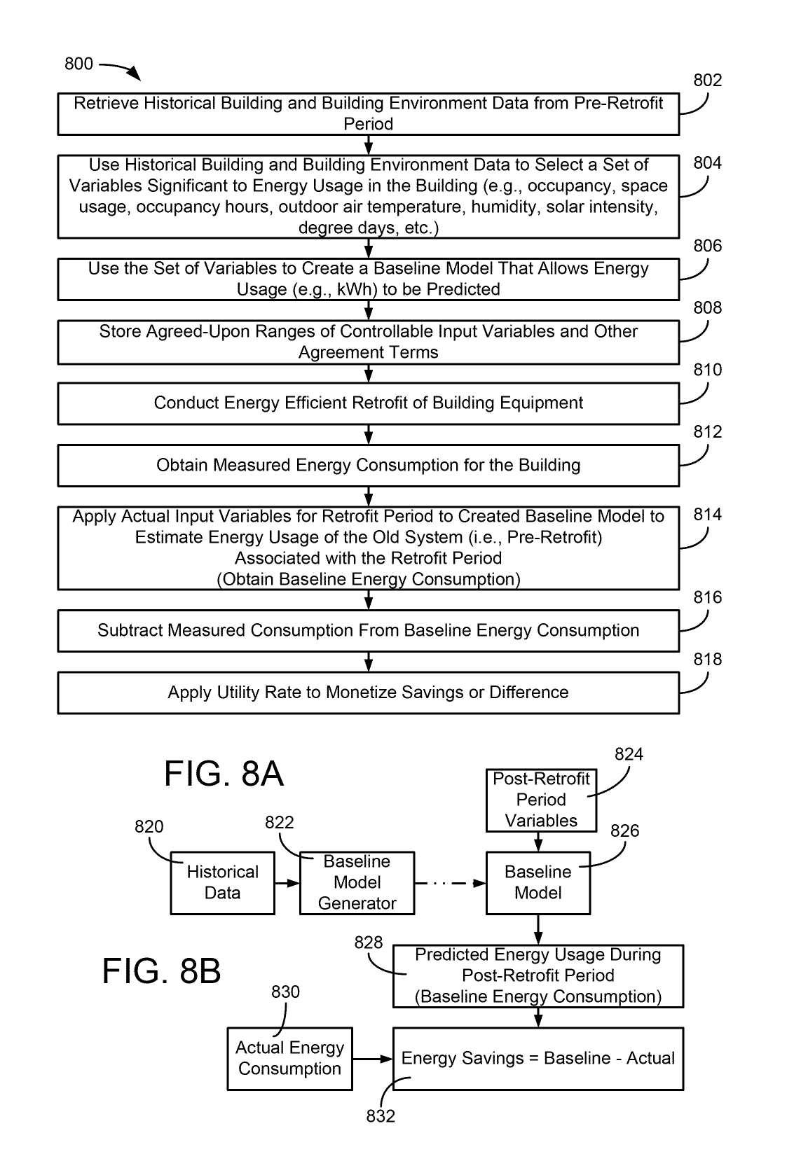

In the illustration of FIG. 7, a building management system enterprise server 706 for the plurality of BMSs of the plurality of buildings 702,704 calculates energy savings or pre-retrofit energy estimations for the plurality of buildings 702,704. In the embodiment of FIG. 7, the server 706 may be remote from buildings 702, 704 and the building's BMSs. In an exemplary embodiment, for example, server 706 is an Internet or “cloud-based” server configured to provide software as a service to BMSs for buildings 702, 704 and for OwCo 710. The server 706 includes an energy savings estimator 708. Energy savings estimator 708 can include the M&V services, baseline model, and estimator described throughout this specification. The OwCo 710 can receive an estimation from the energy savings estimator 708. The OwCo 710 may generate an invoice for the tenant or building owner based on the an estimate of the utility cost (e.g., energy cost, combined natural resource cost, water cost, etc.) had energy efficient improvement measures not been applied to the buildings 702, 704. The OwCo 710 can collect actual utility cost information from utilities 712, 714. The OwCo 710 may pay an energy services company and the investors of the energy efficient improvements using the difference between the actual utility costs from the utilities 712, 714 and the amount invoiced to the building owner or tenant for the estimated utility cost (e.g., based on the utility cost that would have been achieved had the energy efficient measures not been installed).

Pre-Retrofit Energy Consumption Model (i.e., Baseline Model) and Related Measurement and Verification Services

Embodiments of the present disclosure are configured to automatically (e.g., via a computerized process) calculate a pre-retrofit energy consumption model (i.e., baseline model). The pre-retrofit energy consumption model may be used in measuring and verifying energy savings or used in estimating energy consumption that would have been consumed had the new building improvement measures not been installed. The calculation of the baseline model may occur by applying a partial least squares regression (PLSR) method to data from a BMS. The baseline model is used to predict energy consumption and peak demand reductions in a building if building improvement measures (e.g., energy efficient building equipment) were not installed or used in the building. Actual energy consumption using the energy conservation measure is subtracted from the predicted energy consumption to obtain an energy savings estimate or peak demand estimate.

The computerized process can utilize many collinear or highly correlated data points from the BMS to calculate the baseline model using the PLSR algorithm. Data clean-up, data synchronization, and regression analysis activities of the computerized process can be used to prepare the data and to tune the baseline model for improved performance relative to the pertinent data. Further, baseline contractual agreements and violations based on the generated baseline model may be determined with a predetermined statistical confidence.

To provide improved performance over conventional approaches to baseline calculations, an exemplary embodiment includes the following features: one or more computerized modules for automatically identifying which predictor variables (e.g., controllable, uncontrollable, etc.) are the most important to an energy consumption prediction and a computerized module configured to automatically determine the baseline model using the identified predictor variables determined to be the most important to the energy consumption prediction.

While the embodiments shown in the figures mostly relate to measuring and verifying energy consumption and energy savings in a building with the use of expected values as inputs, it should be understood that the systems and methods below may be used to measure and verify peak demand consumption and savings with the use of maximum values as inputs.

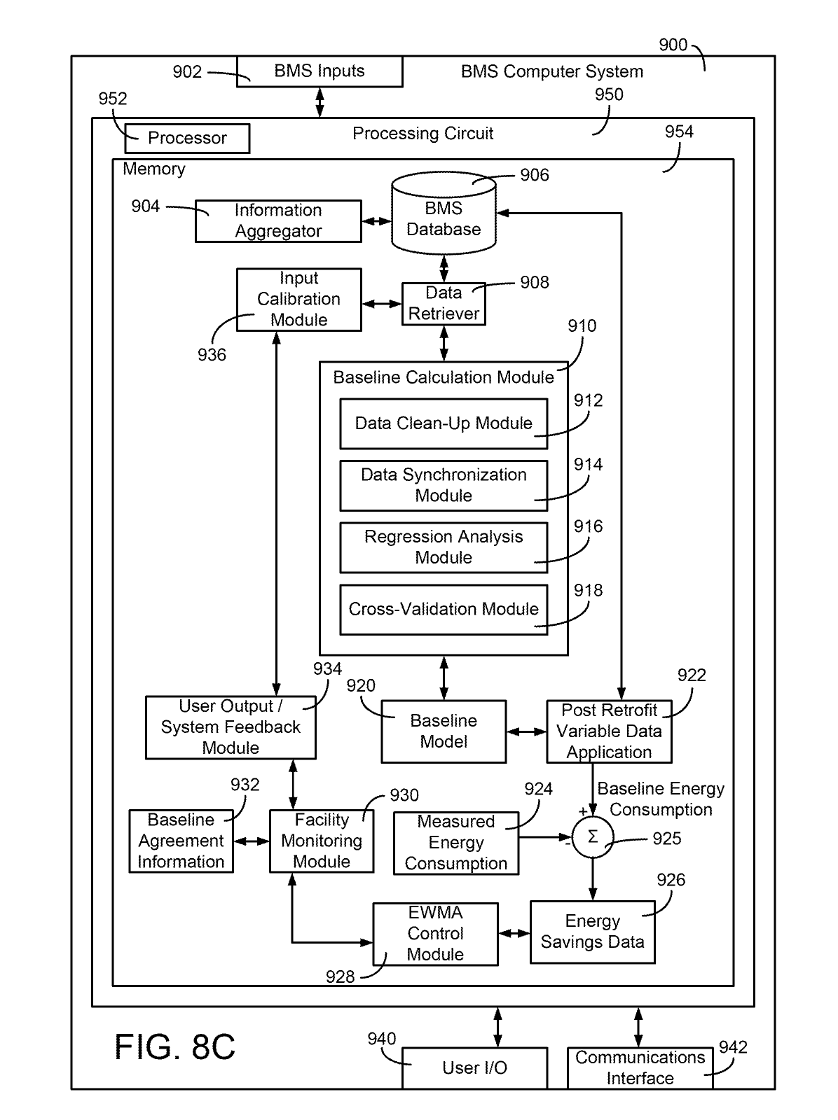

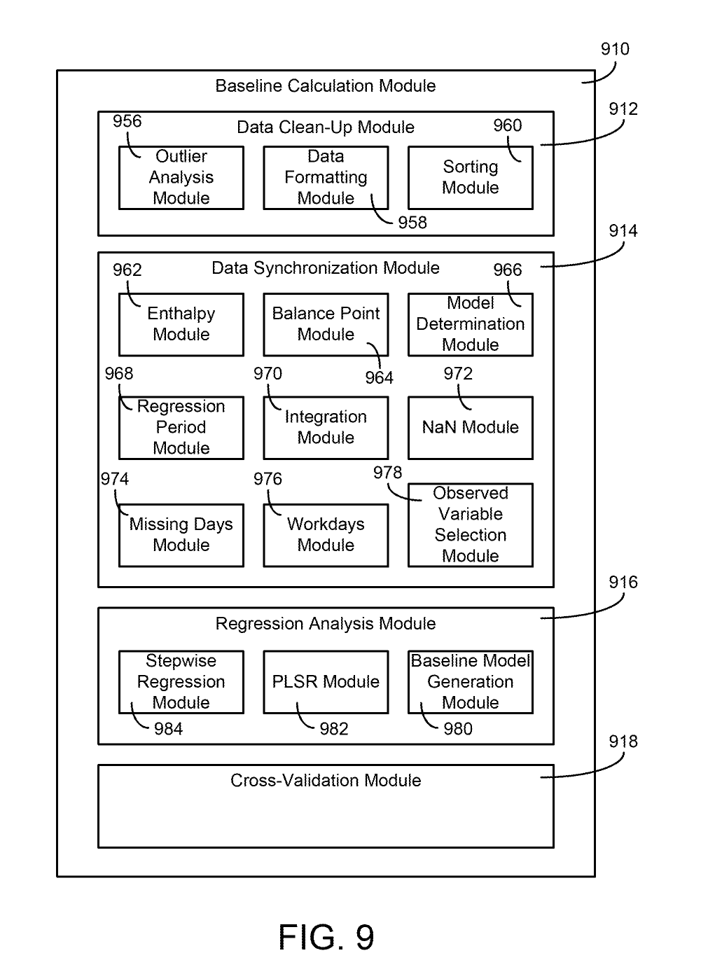

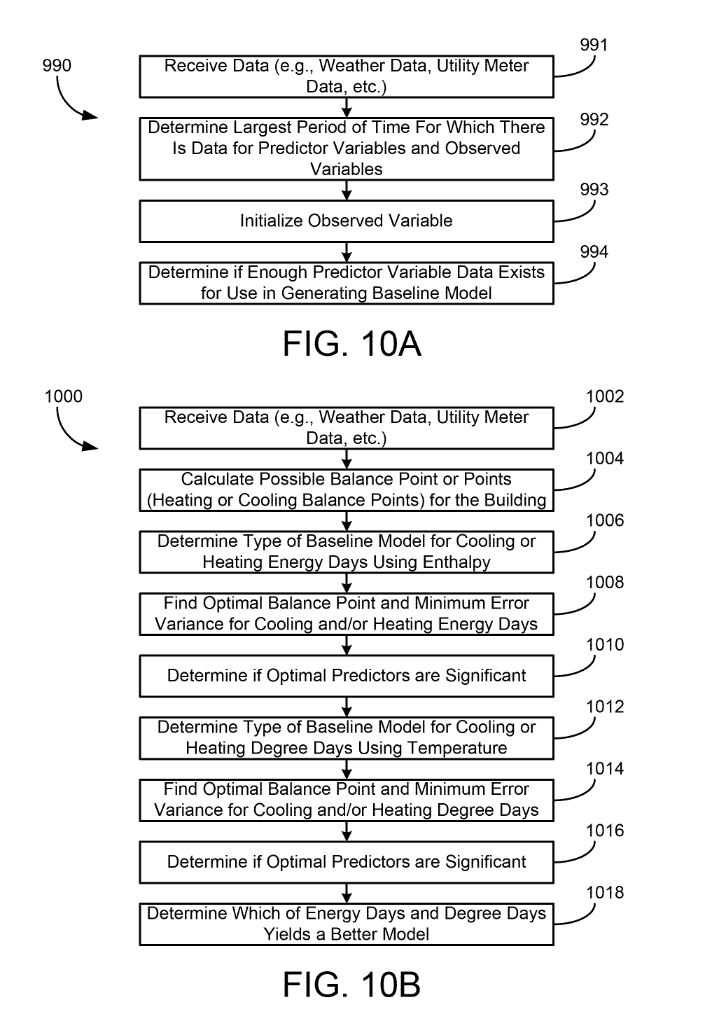

Referring now to FIGS. 8A and 8B, a process 800 for measuring and verifying energy savings and peak demand in a building is shown, according to an exemplary embodiment. Process 800 is shown to include retrieving historical building and building environment data 820 from a pre-retrofit period (step 802). Input variables retrieved in step 802 and used in subsequent steps may include both controllable variables (i.e., variables that may be controlled by a user such as occupancy of an area and space usage) and uncontrollable variables (e.g., outdoor temperature, solar intensity and duration, humidity, other weather occurrences, etc.).

Process 800 further includes using the data obtained in step 802 to calculate and select a set of variables significant to energy usage in the building (step 804). Step 804 may include calculating variables that may be used to determine energy usage in the building. For example, calculated variables such as cooling degree days, heating degree days, cooling energy days, or heating energy days that are representative of energy usage in the building relating to an outside air temperature and humidity may be calculated. Energy days (cooling energy days and heating energy days) are herein defined as a predictor variable that combines both outside air temperature and outside air humidity. Energy days differ from degree days at least in that the underlying integration is based on the calculated outside air enthalpy. Step 804 may include the selection of a set of calculated variables, variables based on a data set from the data received in step 802, or a combination of both. For example, the set of variables may include variables associated with a data set of the building (e.g., occupancy and space usage of an area, outdoor air temperature, humidity, solar intensity) and calculated variables (e.g., occupancy hours, degree days, energy days, etc.). Variables and data that are not significant (e.g., that do not have an impact on energy usage in the building) may be discarded or ignored by process 800.

The set of variables is then used to create a baseline model 826 that allows energy usage or power consumption to be predicted (step 806). With reference to the block diagram of FIG. 8B, baseline model 826 may be calculated using a baseline model generator 822 (e.g., a computerized implementation of a PLSR algorithm).

Process 800 further includes storing agreed-upon ranges of controllable input variables and other agreement terms in memory (step 808). These stored and agreed-upon ranges or terms are used as baseline model assumptions in some embodiments. In other embodiments the baseline model or a resultant contract outcome may be shifted or changed when agreed-upon terms are not met.

Process 800 further includes conducting an energy efficient retrofit of building equipment (step 810). The energy efficient retrofit may include any one or more processes or equipment changes or upgrades expected to result in reduced energy consumption by a building. For example, an energy efficient air handling unit having a self-optimizing controller may be installed in a building in place of a legacy air handling unit with a conventional controller.

Once the energy efficient retrofit is installed, process 800 begins obtaining measured (e.g., actual) energy consumption 830 for the building (step 812). The post-retrofit energy consumption 830 may be measured by a utility provider (e.g., power company), a system or device configured to calculate energy expended by the building HVAC system, or otherwise.

Process 800 further includes applying actual input variables 824 of the post-retrofit period to the previously created baseline model 826 to predict energy usage of the old system during the post-retrofit period (step 814). This step results in obtaining a baseline energy consumption 828 (e.g., in kWh) against which actual energy consumption 830 from the retrofit can be compared.

In an exemplary embodiment of process 800, estimated baseline energy consumption 828 is compared to measured energy consumption 830 by subtracting measured energy consumption 830 during the post-retrofit period from estimated baseline energy consumption 828 (step 816). This subtraction will yield the energy savings 832 resulting from the retrofit. The energy savings 832 resulting from the retrofit is multiplied or otherwise applied to utility rate information for the retrofit period to monetize the savings (step 818). Steps 814 and 816 may further include determining a peak demand reduction in the building and monetizing cost related to the reduction.

Referring now to FIG. 8C, a more detailed block diagram of a BMS computer system 900 for measuring and verifying energy savings in a building is shown, according to an exemplary embodiment. System 900 includes multiple inputs 902 from disparate BMS sources. Inputs 902 are received and parsed or otherwise negotiated by an information aggregator 904 of the processing circuit 950.

BMS computer system 900 includes a processing circuit 950 including a processor 952 and memory 954. Processor 952 can be implemented as a general purpose processor, an application specific integrated circuit (ASIC), one or more field programmable gate arrays (FPGAs), a group of processing components, or other suitable electronic processing components. Memory 954 is one or more devices (e.g., RAM, ROM, Flash memory, hard disk storage, etc.) for storing data and/or computer code for completing and/or facilitating the various processes, layers, and modules described in the present disclosure. Memory 954 may be or include volatile memory or non-volatile memory. Memory 954 may include database components, object code components, script components, or any other type of information structure for supporting the various activities and information structures described in the present disclosure. According to an exemplary embodiment, memory 954 is communicably connected to processor 952 via processing circuit 950 and includes computer code for executing (e.g., by processing circuit 950 and/or processor 952) one or more processes described herein.

Memory 954 includes information aggregator 904. Information aggregator 904 may serve as middleware configured to normalize communications or data received from the multiple inputs. Information aggregator 904 may be a middleware appliance or module sold by Johnson Controls, Inc. Information aggregator 904 is configured to add data to a BMS database 906. A data retriever 908 is configured to retrieve (e.g., query) data from BMS database 906 and to pass the retrieved data to baseline calculation module 910.

Baseline calculation module 910 is configured to create a baseline model using historical data from the multiple inputs and aggregated in BMS database 906 or other data sources. Some of the information may be received from sources other than building data sources (e.g., weather databases, utility company databases, etc.). The accuracy of the baseline model will be dependent upon errors in the data received.

Baseline calculation module 910 is shown to include data clean-up module 912. Data clean-up module 912 receives data from data retriever 908 and prefilters the data (e.g., data scrubbing) to discard or format bad data. Data clean-up module 912 conducts one or more checks to determine whether the data is reliable, whether the data is in the correct format, whether the data is or includes a statistical outlier, whether the data is distorted or “not a number” (NaN), whether the sensor or communication channel for a set of data has become stuck at some value, and if the data should be discarded. Data clean-up module 912 may be configured to detect errors via, for example, threshold checks or cluster analysis.

Baseline calculation module 910 is further shown to include data synchronization module 914. Data synchronization module 914 receives the data after the data is “cleaned up” by data clean-up module 912 and is configured to determine a set of variables for use in generating the baseline model. The variables may be calculated by module 914, may be based on received data from data retriever 908 and data clean-up module 912, or a combination of both. For example, data synchronization module 914 may determine variables (e.g., cooling and heating degree days and cooling and heating energy days) that serve as a proxy for energy usage needed to heat or cool an area of the building. Data synchronization module 914 may then further determine which type of calculated variable to use (e.g., whether to use degree days or energy days in the regression analysis that generates the baseline model). Further, data synchronization module 914 may identify and use measured data received from data retriever 908 and formatted by data clean-up module 912 for use in the set of variables. For example, module 914 may select temperature data received from data retriever 908 as a predictor variable for energy usage in the building.

Baseline calculation module 910 further includes regression analysis module 916. Regression analysis module 916 is configured to generate the baseline model based on the set of variables from data synchronization module 914. According to one exemplary embodiment, a partial least squares regression (PLSR) method may be used to generate the baseline model. According to other embodiments, other regression methods (e.g., principal component regression (PCR), ridge regression (RR), ordinary least squares regression (OLSR)) are also or alternatively used in the baseline model calculation. The PLSR method is based on a linear transformation from the set of variables from module 914 to a linear model that is optimized in terms of predictivity.

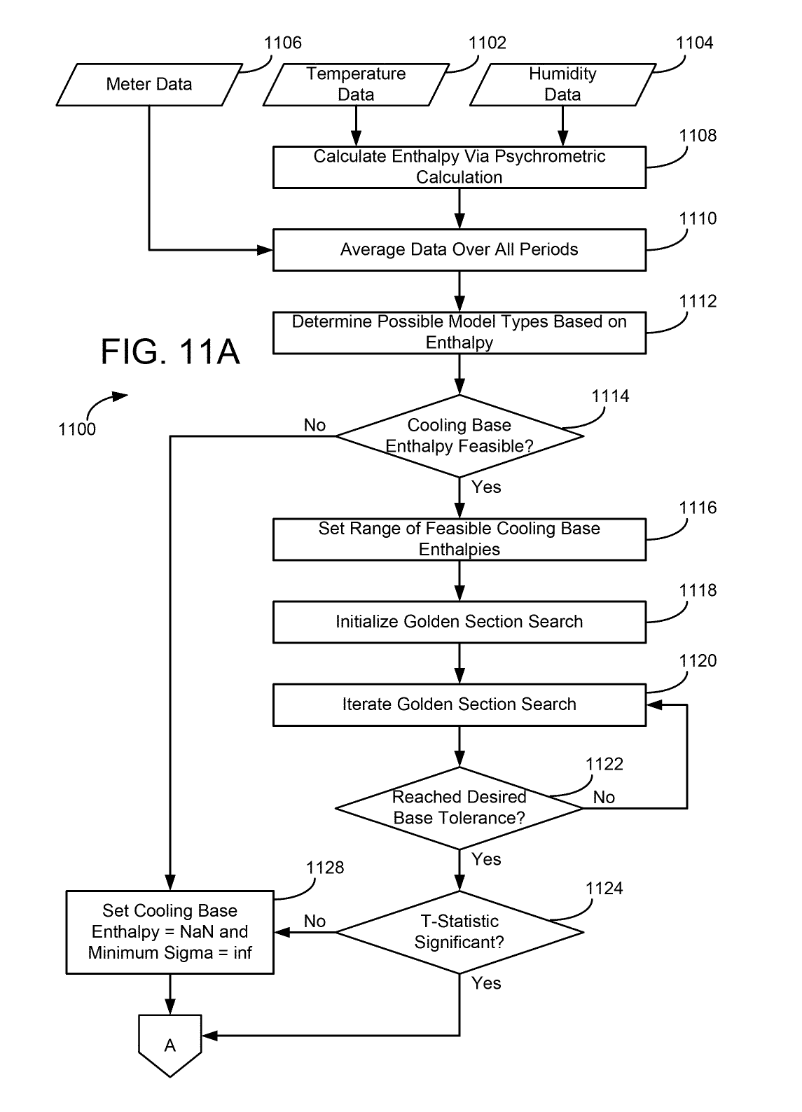

Baseline calculation module 910 further includes cross-validation module 918. Cross-validation module 918 is configured to validate the baseline model generated by regression analysis module 916. Validation of the baseline model may include ensuring there is no overfitting of the baseline model (e.g., having too many variables or inputs influencing the model), determining a correct order or number of components in the model, or conducting other tests or checks of the baseline module output by regression analysis module 916. Baseline calculation module 910 and sub-modules 912-918 are shown in greater detail in FIG. 9 and subsequent figures.

Post retrofit variable data 922 is applied to baseline model 920 generated by baseline calculation module 910 (e.g., data relating to estimated energy use of the building) to obtain a resultant baseline energy consumption. Measured energy consumption 924 from the building is subtracted from the resultant baseline energy consumption at element 925 to obtain energy savings data 926. Energy savings data 926 may be used to determine payments (e.g., from the retrofit purchaser to the retrofit seller), to demonstrate the new equipment's compliance with a guaranteed level of performance, or as part of a demand-response commitment or bid validation. Energy savings data 926 may relate to overall energy consumption and/or peak demand reduction.

Energy savings data 926 or other information from the prior calculations of the system is used to monitor a building after retrofit to ensure that the facility occupants have not violated the terms of the baseline agreement (e.g., by substantially adding occupants, by changing the building space use, by bringing in more energy using devices, by substantially changing a setpoint or other control setting, etc.). Conventionally this involves making periodic visits to the facilities, reviewing job data, and/or making specialized measurements. Because visits and specialized reviews are time consuming, they are often not done, which puts any savings calculations for a period of time in question.

System 900 includes an Exponentially Weighted Moving Average (EWMA) control module 928 configured to automate a baseline term validation process. EWMA control module 928 monitors the difference between the predicted and measured consumption. Specifically, EWMA control module 928 checks for differences between the predicted and measured consumption that are outside of predetermined statistical probability thresholds and provides the results to a facility monitoring module 930. Any statistically unlikely occurrences can cause a check of related data against baseline agreement information 932, used to update baseline agreement information, or are provided to a user output/system feedback module 934. User output/system feedback module 934 may communicate alarm events to a user in the form of a displayed (e.g., on an electronic display) EWMA chart configured to highlight unexpected shifts in the calculated energy savings. Input calibration module 936 may receive feedback from module 934 and additionally provide data to data retriever 908 regarding instructions to add or remove variables from consideration for the baseline model in the future. In other embodiments, different or additional control modules may implement or include statistical process control approaches other than or in addition to EWMA to provide baseline validation features.

BMS computer system 900 further includes a user input/output (I/O) 940. User I/O 940 is configured to receive a user input relating to the data set used by baseline calculation module 910 and other modules of system 900. For example, user I/O 940 may allow a user to input data into system 900, edit existing data points, etc. System 900 further includes communications interface 942. Communications interface 942 can be or include wired or wireless interfaces (e.g., jacks, antennas, transmitters, receivers, transceivers, wire terminals, etc.) for conducting data communications with the BMS, subsystems of the BMS, or other external sources via a direct connection or a network connection (e.g., an Internet connection, a LAN, WAN, or WLAN connection, etc.).

Referring now to FIG. 9, baseline calculation module 910 is shown in greater detail, according to an exemplary embodiment. Baseline calculation module 910 includes data clean-up module 912. Data clean-up module 912 receives data from the BMS computer system of the building and pre-filters the data for data synchronization module 914 and the other modules of baseline calculation module 910. Data clean-up module 912 includes outlier analysis module 956, data formatting module 958, and sorting module 960 for pre-filtering the data. Data clean-up module 912 uses sub-modules 956-960 to discard or format bad data by normalizing any formatting inconsistencies with the data, removing statistical outliers, or otherwise preparing the data for further processing. Data formatting module 958 is configured to ensure that like data is in the same correct format (e.g., all time-based variables are in the same terms of hours, days, minutes, etc.). Sorting module 960 is configured to sort data for further analysis (e.g., place in chronological order, etc.).

Outlier analysis module 956 is configured to test data points and determine if a data point is reliable. For example, if a data point is more than a threshold (e.g., three standard deviations, four standard deviations, or another set value) away from the an expected value (e.g., the mean) of all of the data points, the data point may be determined as unreliable and discarded. Outlier analysis module 956 may further calculate the expected value of the data points that each data point is to be tested against. Outlier analysis module 956 may be configured to replace the discarded data points in the data set with a NaN or another flag such that the new value will be skipped in further data analysis.

According to another exemplary embodiment, outlier analysis module 956 can be configured to conduct a cluster analysis. The cluster analysis may be used to help identify and remove unreliable data points. For example, a cluster analysis may identify or group operating states of equipment (e.g., identifying the group of equipment that is off). A cluster analysis can return clusters and centroid values for the grouped or identified equipment or states. The centroid values can be associated with data that is desirable to keep rather than discard. Cluster analyses can be used to further automate the data clean-up process because little to no configuration is required relative to thresholding.

Data clean-up module 912 may further include any other pre-filtering tasks for sorting and formatting the data for use by baseline calculation module 910. For example, data clean-up module 912 may include an integrator or averager which may be configured to smooth noisy data (e.g., a varying number of occupants in a building area). The integrator or averager may be used to smooth data over a desired interval (e.g., a 15 minute average, hourly average, etc.).

Baseline calculation module 910 includes data synchronization module 914. Data synchronization module 914 is configured to select a possible set of variables estimated to be significant to energy usage in the building. Data synchronization module 914 selects the possible set of variables (e.g., a preliminary set of variables) that are provided to stepwise regression module 984 for selection of the actual set of variables to use to generate the baseline model. According to various exemplary embodiments, the selection of some or all of the set of variables to use for baseline model generation may occur in data synchronization module 914, stepwise regression analysis 984, or a combination of both. Data synchronization module 914 includes sub-modules for calculating predictor variables and selecting one or more of the predicted variables to include in the possible set of variables. Data synchronization module 914 further includes sub-modules for selecting observed (e.g., measured) data points for the set of variables.

According to one exemplary embodiment, data synchronization module 914 is configured to calculate degree days and energy days (e.g., a predictor variable associated with heating or cooling of a building) and determine which of these predictors should be used to yield a better baseline model. The outputs of data synchronization module 914 (e.g., inputs provided to regression analysis module 916) may include the measurements or predictor variables to use, a period of time associated with the measurements or predictor variables, and errors associated with the data included in the measurements or predictor variables.

Data synchronization module 914 includes enthalpy module 962, balance point module 964, model determination module 966, regression period module 968, integration module 970, NaN module 972, missing days module 974, workdays module 976, and observed variable selection module 978. Enthalpy module 962 is configured to calculate an enthalpy given a temperature variable and a humidity variable. Enthalpy module 962 combines an outdoor temperature variable and an outside air humidity variable via a nonlinear transformation or another mathematical function into a single variable. The single variable may then be used by baseline calculation module 910 as a better predictor of a building's energy use than using both temperature and humidity values separately.

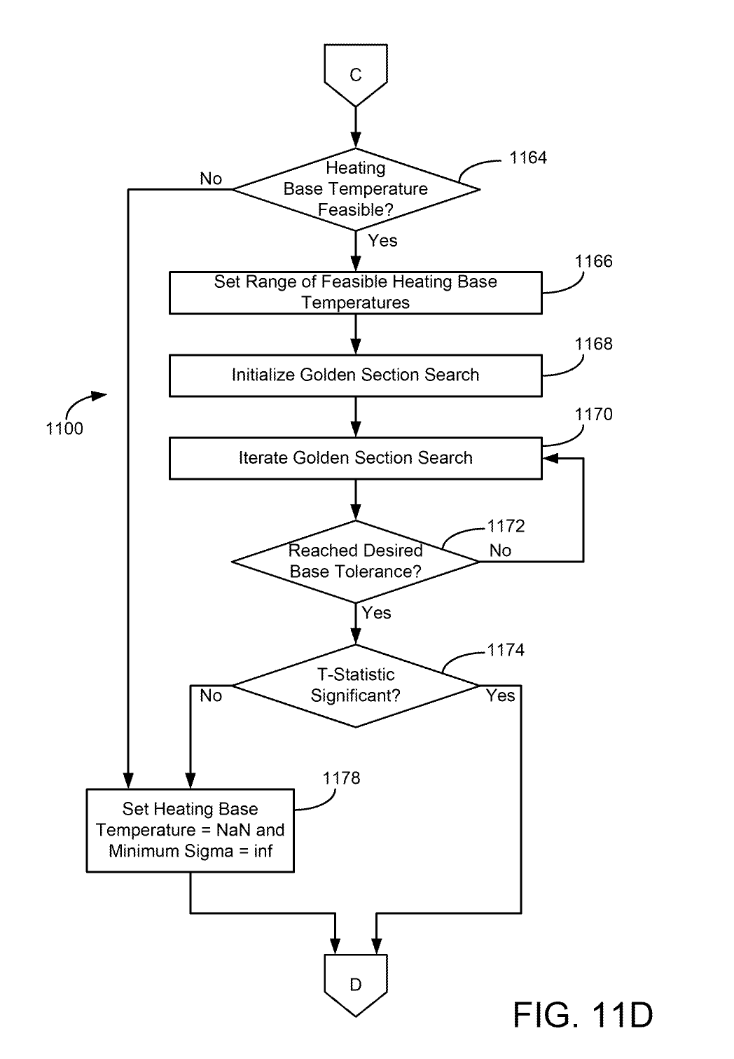

Balance point module 964 is configured to find an optimal balance point for a calculated variable (e.g., a variable based on an enthalpy value calculated in enthalpy module 962, an outdoor air temperature variable, etc.). Balance point module 964 determines a base value for the variable for which the estimated variance of the regression errors is minimized. Model determination module 966 is configured to determine a type of baseline model to use for measuring and verifying energy savings. The determination may be made based on an optimal balance point generated by balance point module 964. Modules 964, 966 are described in greater detail in FIGS. 11A-11E.

Regression period module 968 is configured to determine periods of time that can be reliably used for model regression by baseline calculation module 910 and data synchronization module 914. Regression period module 968 may identify period start dates and end dates associated with calculated and measured variables for the data synchronization. Regression period module 968 may determine the start date and end date corresponding with the variable with the longest time interval (e.g., the variable for which the most data is available). For example, regression period module 968 determines the period by finding the period of time which is covered by all variables, and providing the start date and end date of the intersection to data synchronization module 914. Regression period module 968 is further configured to identify data within the periods that may be erroneous or cannot be properly synchronized.

Integration module 970 is configured to perform an integration over a variable structure from a given start and end time period (e.g., a time period from regression period module 968). According to an exemplary embodiment, integration module 970 uses a trapezoidal method of integration. Integration module 970 may receive an input from balance point module 964 or another module of data synchronization module 914 for performing an integration for a balance point determined by balance point module 964. NaN module 972 is configured to identify NaN flags in a variable structure. NaN module 972 is further configured to replace the NaN flags in the variable structure via interpolation. NaN module 972 may receive an input from, for example, data clean-up module 912, and may be configured to convert the outlier variables and NaNs determined in module 912 into usable data points via interpolation.

Missing days module 974 is configured to determine days for which is there is not enough data for proper integration performance. Missing days module 974 compares the amount of data for a variable for a given day (or other period of time) and compares the amount to a threshold (e.g., a fraction of a day) to make sure there is enough data to accurately calculate the integral. Workdays module 976 is configured to determine the number of work days in a given interval based on the start date and end date of the interval. For example, for a given start date and end date, workdays module 976 can determine weekend days and holidays that should not figure into the count of number of work days in a given interval. Modules 974, 976 may be used by data synchronization module 914 to, for example, identify the number of days within a time interval for which there exists sufficient data, identify days for which data should not be included in the calculation of the baseline model, etc.

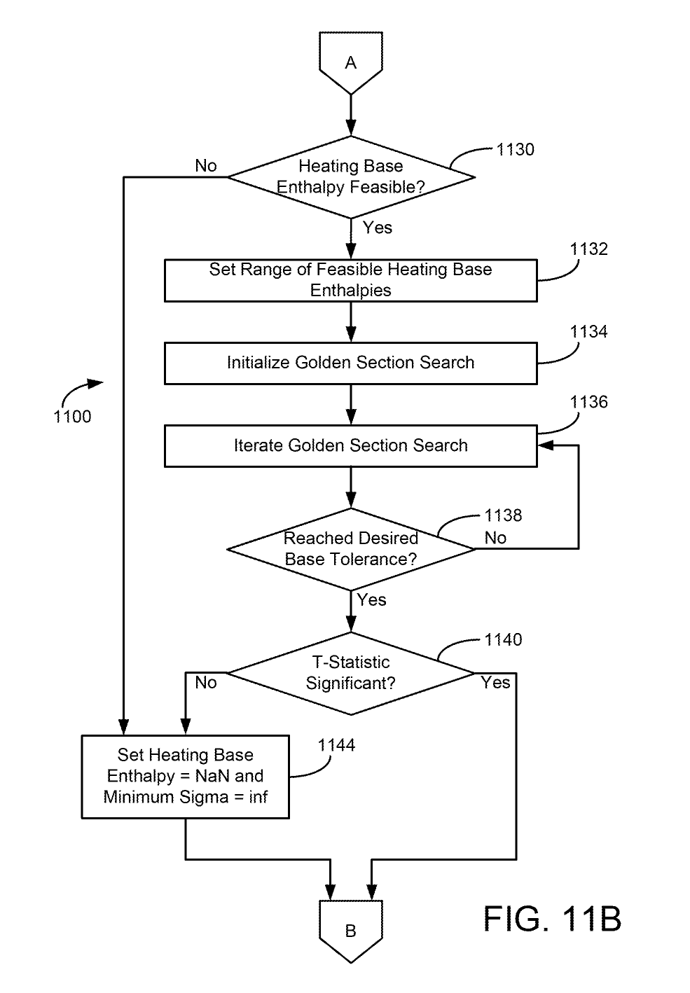

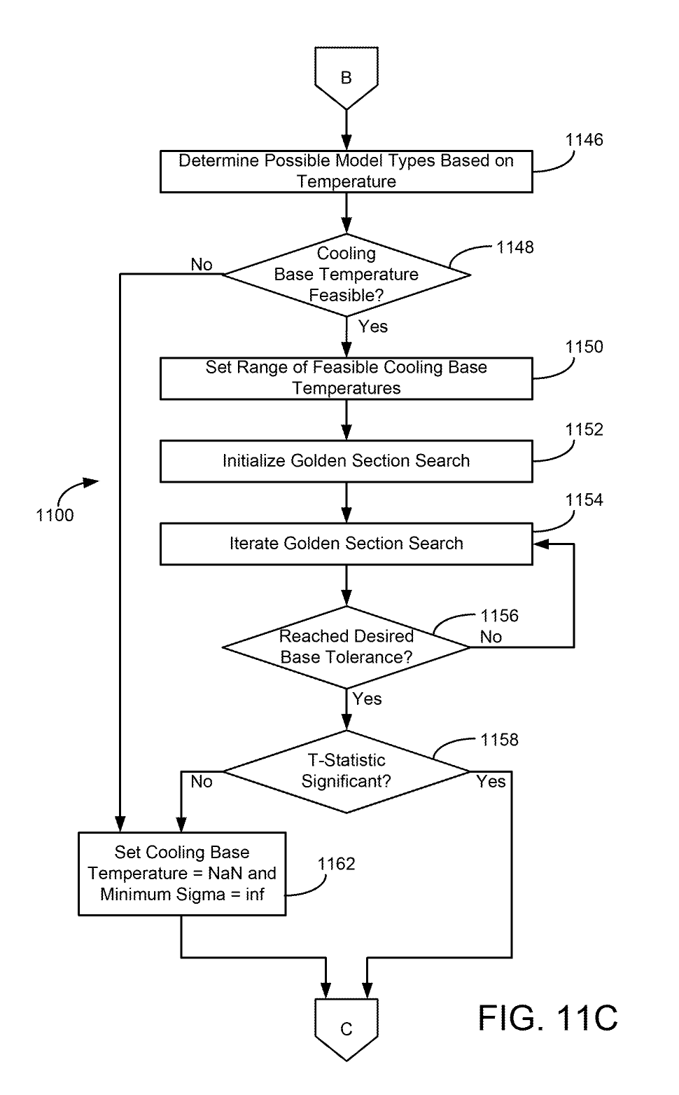

Observed variable selection module 978 is configured to receive observed or measured data from the BMS and determine which observed data should be used for baseline model generation based on the selection of calculated data in modules 964-966. For example, when balance point module 964 determines a calculated variable, observed variable selection module 978 is configured to determine if there is enough predictor variable data for the observed variable. According to an exemplary embodiment, the predictor variable data and observed variable data for a specific variable (e.g., temperature) may only be used when sufficient predictor variable data (e.g., degree days) for the observed variable data exists. For example, if the predictor variable data is available over a specified range (e.g., 20 days, 2 months, or any other length of time), then module 978 may determine there is enough predictor variable data such that the predictor variable data and observed variable data can be used for baseline model generation. Observed variable selection module 978 is described in greater detail in FIG. 10A.

Baseline calculation module 910 further includes regression analysis module 916. Regression analysis module 916 is configured to generate the baseline model via a PLSR method. Regression analysis module 916 includes baseline model generation module 980 for generating the baseline model and PLSR module 982 for receiving data from data synchronization module 914, applying the data to a PLSR method, and providing baseline model generation module 980 with the method output.

Baseline model generation module 980 is configured to generate the baseline model. Baseline model generation module 980 is configured to use PLSR module 982 to perform PLSR of the data and stepwise regression module 984 to determine the predictor variables for the baseline model and to eliminate insignificant variables. Module 980 is configured to provide, as an output, the baseline model along with calculating various statistics for further analysis of the baseline model (e.g., computing the number of independent observations of data in the data set used, computing the uncertainty of the model, etc.). Uncertainty of the model may be provided to other components or systems of FIG. 1A or 1B for use in reporting to an investor, OwCo, ESCO, or building owner. Advantageously the measurement and verification methods described herein may be capable of providing actuarial level statistics (including uncertainty determinations) on the invoices and supporting data described above.

Regression analysis module 916 is further shown to include stepwise regression module 984. Stepwise regression module 984 is configured to perform stepwise linear regression in order to eliminate statistically insignificant predictor variables from an initial set of variables selected by data synchronization module 914. In other words, stepwise regression module 984 uses stepwise regression to add or remove predictor variables from a data set (e.g., the data set from data synchronization module 914) for further analysis.

A stepwise regression algorithm of module 984 is configured to add or remove predictor variables from a set for further analysis in a systematic way. At each step the algorithm conducts statistical hypothesis testing (e.g., by computing a probability of obtaining a test statistic, otherwise known as a p-value, of an F-statistic, which is used to describe the similarity between data values) to determine if the variable should be added or removed. For example, for a particular variable, if the variable would have a zero (or near zero) coefficient if it were in the baseline model, then the variable is removed from consideration for the baseline model. According to various alternative embodiments, other approaches to stepwise regression are used (e.g., factorial designs, principal component analysis, etc.). Referring also to FIG. 8C, instructions to add or remove variables from future consideration based on the analysis of module 916 may be provided to, for example, input calibration module 936 for affecting the queries run by data retriever 908.

PLSR module 982 is configured to receive a subset of the variables from data synchronization module 914 which has been selected by stepwise regression module 984, and to compute a partial least squares regression of the variables in order to generate a baseline model. According to various alternative embodiments, other methods (e.g., a principal component regression (PCR), ridge regression (RR), ordinary least squares regression (OLSR)) are also or alternatively used in the baseline model calculation instead of a PLSR method.

Baseline models calculated using historical data generally include four possible sources of error: modeling errors, sampling errors, measurement errors, and errors relating to multiple distributions in the data set. Sampling errors occur when the number of data samples used is too small or otherwise biased. Measurement errors occur when there is sensor or equipment inaccuracy, due to physics, poor calibration, a lack of precision, etc. Modeling errors (e.g., errors associated with the data set) occur due to inaccuracies and inadequacies of the algorithm used to generate the model. Errors relating to multiple distributions in the data set occur as more data is obtained over time. For example, over a one to three year period, data may be collected for the period and older data may become obsolete as conditions change. The older data may negatively impact the prediction capabilities of the current baseline model.

Conventional baseline energy calculations use ordinary least squares regression (OLS). For example, ASHRAE Guideline 14-2002 titled “Measurement of Energy Demand Savings” and “The International Performance Measurement and Verification Protocol” (IPMVP) teach that OLS should be used for baseline energy calculations. For OLS:

γ=1*β₀+Xβ_{OLS}+ε

where γ is a vector of the response variables, X is a matrix consisting of n observations of the predictor variables, β₀ is an unknown constant, β_{OLS} is an unknown vector of OLS regression coefficients, and c is a vector of independent normally distributed errors with zero mean and variance σ². The regression coefficients are determined by solving the following equation:

β_{OLS}=(X^{T}X)⁻¹X^{T}γ.

PLSR may outperform OLS in a building environment where the inputs to an energy consumption can be many, highly correlated, or collinear. For example, OLS can be numerically unstable in such an environment resulting in large coefficient variances. This occurs when X^{T}X, which is needed for calculating OLS regression coefficients, becomes ill-conditioned in environments where the inputs are many and highly correlated or collinear. In alternative embodiments, PCR or RR are used instead of or in addition to PLSR to generate a baseline model. In the preferred embodiment PLSR was chosen due to its amenability to automation, its feature of providing lower mean square error (MSE) values with fewer components than methods such as PCR, its feature of resolving multicollinearity problems attributed to methods such as OLS, and due to its feature of using variance in both predictor and response variables to construct model components.

Baseline calculation module 910 is further shown to include cross-validation module 918. Cross-validation module 918 is configured to validate the baseline model generated by regression analysis module 916 (e.g., there is no overfitting of the model, the order and number of variables in the model is correct, etc.) by applying data for a test period of time (in the past) to the model and determining whether the model provides a good estimate of energy usage. Cross-validation of the baseline model is used to verify that the model will fit or adequately describe varying data sets from the building. According to one exemplary embodiment, cross-validation module 918 may use a K-fold cross-validation method. The K-fold cross validation method is configured to randomly partition the historical data provided to baseline calculation module 910 into K number of subsamples for testing against the baseline model. In other embodiments, a repeated random sub-sampling process (RRSS), a leave-one-out (LOO) process, a combination thereof, or another suitable cross-validation routine may be used by cross-validation module 918.

Referring now to FIG. 10A, a flow chart of a process 990 for determining observed or measured variables to use in generation of a baseline model is shown, according to an exemplary embodiment. Process 990 is configured to select observed variables based on predictor variables generated by the data synchronization module of the baseline calculation module. Process 990 includes receiving data (step 991). Process 990 further includes determining the largest period of time for which there is data for predictor variables and observed variables (step 992). The period of time determined in step 992 may represent a period of time for which there will be enough predictor variable data for the corresponding data received in step 991. Step 992 may include, for example, removing insufficient data points and determining the longest period for which there is enough data. For example, if there is too little data for one day, it may be determined that a predictor variable for that day may not be generated and therefore the day may not be used in ultimately determining a baseline model.

Process 990 includes initializing the observed variable (step 993). Initializing the observed variable includes determining a start and end point for the observed variable data, determining the type of data and the units of the data, and any other initialization step. Step 993 is used to format the received data from step 991 such that the observed data is in the same format as the predictor variable data.

Process 990 includes determining if enough predictor variable data exists (step 994). For example, if there is enough predictor variables (e.g., energy days) for a set period of time (e.g., 20 days), then process 990 determines that the predictor variables and its associated observed variable (e.g., enthalpy) may be used for baseline model generation.

Referring now to FIG. 10B, a flow chart of a process 1000 for determining calculated variables to use in generation of a baseline model is shown, according to an exemplary embodiment. Selecting some calculated variables for inclusion in a regression analysis used to generate a baseline model may provide better results than selecting some other calculated variables for inclusion, depending on the particulars of the building and its environment. In other words, proper selection of calculated variables can improve a resultant baseline model's ability to estimate or predict a building's energy use. Improvements to energy use prediction or estimation capabilities can improve the performance of algorithms that rely on the baseline model. For example, an improved baseline model can improve the performance of demand response algorithms, algorithms for detecting abnormal energy usage, and algorithms for verifying the savings of an energy conservation measure (e.g., M&V calculations, etc.).

Process 1000 provides a general process for selecting calculated variables to use in generation of a baseline model. FIGS. 11A-11E provide a more detailed view of process 1000. The output of process 1000 (and of the processes shown in FIGS. 11A-11E) is the selection of calculated variables to use to generate the baseline model. Particularly, in an exemplary embodiment, process 1000 selects between cooling energy days, heating energy days, cooling degree days, and heating degree days. The selection relies on a calculation of balance points (e.g., optimal base temperatures or enthalpies) of a building and using the calculations to calculate the potential variables (e.g., the energy days and degree days) for selection into the set of variables used to generate the baseline model.

The calculation and selection of calculated variables (for inclusion into the baseline model generation) is based in part on calculated balance points and may be accomplished in different ways according to different exemplary embodiments. According to one embodiment, a nonlinear least squares method (e.g., a Levenburg-Marquardt method) may be used to find the best calculated variables. Such a method, for example, may use daily temperature and energy meter readings to calculate balance points. A nonlinear least squares method may then be applied to the balance points to generate and select the appropriate calculated variables.

According to another embodiment, an optimization scheme may be used to determine the best balance point or points. The optimization scheme may include an exhaustive search of the balance points, a gradient descent algorithm applied to the balance points to find a local minimum of the balance points, a generalized reduced gradient method to determine the best balance point, and a cost function that is representative of the goodness of fit of the best balance point. The cost function may be an estimated variance of the model errors obtained from an iteratively reweighted least squares regression method, according to an exemplary embodiment. The iteratively reweighted least squares regression method is configured to be more robust to the possibility of outliers in the set of balance points generated and can therefore provide more accurate selections of calculated variables.

The optimization scheme algorithm may also use statistics (e.g., a t-statistic representative of how extreme the estimated variance is) to determine if building energy use is a function of, for example, heating or cooling. The statistics may be used to determine which balance points to calculate as necessary (e.g., calculating balance points relating to heating if statistics determine that building energy use is based on heating the building.

Referring to FIG. 10B and FIGS. 11A-11E, an optimization scheme is described which uses a golden section search rule to calculate energy days and degree days and to determine which of the calculated variables to use based on a statistics to determine the type of energy use in the building.

Process 1000 includes receiving data such as temperature data, humidity data, utility meter data, etc. (step 1002). Process 1000 further includes using the received data to calculate possible balance points (step 1004). For example, step 1004 may include using the received temperature data and humidity data to calculate an enthalpy. As another example, step 1004 may include determining an optimal base temperature using the received temperature data. Process 1000 further includes steps 1006-1018 for determining a calculated variable to use for baseline model generation based on enthalpy and temperature data calculated in step 1004; according to various exemplary embodiments, steps 1006-1018 of process 1000 may be used to determine calculated variables based on other types of balance points.

Process 1000 includes steps 1006-1010 for determining optimal predictor variables based on the enthalpy calculated in step 1004. Process 1000 includes determining a type of baseline model for cooling or heating energy days using the enthalpy (step 1006). Process 1000 further includes finding an optimal enthalpy balance point or points and minimum error variance for the resultant cooling and/or heating energy days (step 1008). The optimal enthalpy balance point relates to, for example, a preferred base enthalpy of the building, and the minimum error variance relates to the variance of the model errors at the optimal balance point (determined using IRLS). Process 1000 further includes determining if the optimal predictors determined in step 1008 are significant (step 1010).

Process 1000 includes steps 1012-1016 for determining optimal predictor variables based on a temperature (e.g., temperature data received in step 1002 by baseline calculation module 910). Process 1000 includes determining a type of baseline model for cooling or heating degree days using the temperature (step 1012). Process 1000 further includes finding an optimal temperature balance point and minimum error variance for the cooling and/or heating degree days (step 1014). Process 1000 also includes determining if the optimal predictors determined in step 1014 are significant (step 1016). Using the results of steps 1006-1016, process 1000 determines which of energy days and degree days yields a better (e.g., more accurate) baseline model (step 1018) when used by baseline calculation module 910.

Referring now to FIGS. 11A-11E, a detailed flow chart of process 1000 of FIG. 10B is shown, according to an exemplary embodiment. Process 1100 of FIGS. 11A-11E is shown using enthalpy and temperature to determine the balance points. The balance points are used to calculate the optimal degree or energy days predictor variable and in determining which calculated variables to use for baseline model generation. According to other embodiments, other methods may be used to determine the balance points. Referring more specifically to process 1100 shown in FIG. 11A, process 1100 may calculate an enthalpy using temperature data input 1102 and humidity data 1104 (step 1108). According to an exemplary embodiment, enthalpy may be calculated using a psychometric calculation. Process 1100 includes receiving meter data 1106 and enthalpy data and averages the data over all periods (step 1110) for use in the rest of process 1100.

Process 1100 includes determining possible baseline model types (i.e., whether both the heating and cooling balance points are needed to describe energy use in the building) based on the calculated enthalpy (step 1112). For example, step 1112 includes the method of determining a predictor variable associated with minimum energy use and then sorting all of the calculated variables (e.g., the variables determined in steps 1108-1110) and finding where the minimum energy predictor variable ranks compared to the other predictor variables.

Process 1100 includes determining if using cooling base enthalpy in the baseline model calculation is feasible (step 1114). If the predictor variable associated with the minimum energy found in step 1112 is close enough to the maximum calculated variable, then it may be determined that a cooling base does not exist because cooling does not significantly impact energy consumption in the building or it cannot be found due to lack of data. If using the cooling base enthalpy is not feasible, the cooling base enthalpy is set to NaN and the minimum sigma is set to infinity (step 1128) such that both values will be “ignored” later by process 1100.

If using a cooling base enthalpy is feasible, a range of feasible cooling base enthalpies is set (step 1116). The range may vary from the maximum average monthly enthalpy to ten units less than the predictor variable associated with the minimum energy use.

Process 1100 includes finding the base temperature of the predictor variable (e.g., via balance point module 964) by finding the base enthalpy for which the estimated variance of the regression errors is minimized. According to one exemplary embodiment, the minimization may be performed using the golden section search rule. Process 1100 includes initializing the golden section search (step 1118) and iterating the golden section search (step 1120) until a desired base tolerance has been reached (step 1122). The base tolerance may be predetermined via a logarithmic function of the size of the range, according to an exemplary embodiment. The golden section search of steps 1120-1122 provides an optimal balance point. The optimal balance point is then used to calculate a measure of variability and determine the t-statistic for the predictor variable.

When a desired base tolerance has been reached for the golden section search (step 1122), process 1100 may determine whether the t-statistic is significant (step 1124). If the t-statistic is not significant, the minimum sigma representative of the t-statistic is set to infinity (step 1128). If the t-statistic is significant, it is used in a later step of process 1100 to determine the best predictor variable to use for the baseline model.

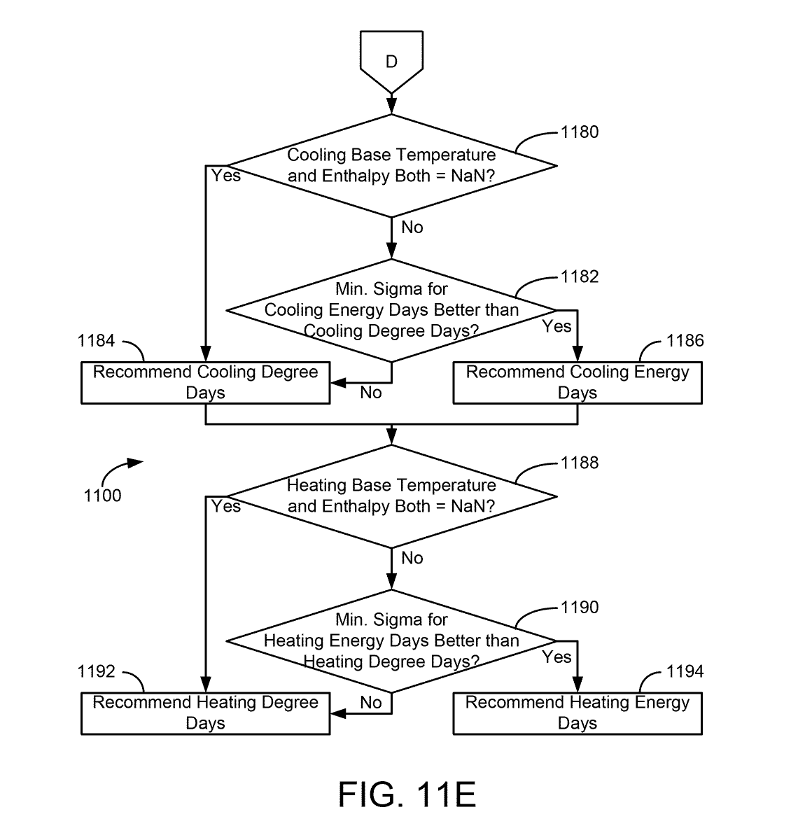

Referring now to FIG. 12, the objective function used in the golden section search of FIGS. 11A-11E is shown in greater detail, according to an exemplary embodiment. Process 1200 is configured to calculate the objective function for use in the golden section search. Process 1200 includes receiving data from, for example, step 1116 of process 1100 relating to a range of enthalpies or temperatures (or other measurements) that may be used for the baseline model. Process 1200 includes, for all periods, finding an average predictor variable for each given balance point (step 1202). For example, the following integral may be used to find the predictor variable:

$$\frac{1}{T} {{\int }_{periodstart}}^{periodend} max ( 0 , X ( t ) - b ) d t$$

while the following integral may be used to determine the average response variable:

$$\frac{1}{T} {{\int }_{periodstart}}^{periodend} Y ( t ) d t$$

where b is the balance point and T is the length of the period.

After obtaining the predictor variable, process 1200 includes performing an iteratively reweighted least squares method (IRLS) (step 1204). IRLS is used because it is more robust to outliers than standard OLS methods. Process 1200 includes using the results of step 1204 to obtain an estimate of the error variance (step 1206) which is used by process 1100 to determine the predictor variable with the best fit for generating a baseline model.

Referring back to FIGS. 11A-11E, process 1100 further includes repeating the steps of steps 1114-1128 for the heating base enthalpy instead of the cooling base enthalpy. Referring now to FIG. 11B, process 1100 includes determining if heating base enthalpy is feasible (step 1130), setting a range of feasible heating base enthalpies (step 1132), initializing a golden section search (step 1134), iterating the golden section search (step 1136) until a desired base tolerance is reached (step 1138), and determining if the t-statistic is significant (step 1140). If the t-statistic is not significant, the minimum sigma is set to infinity (step 1144), and if otherwise, the t-statistic will be used later in process 1100.

Process 1100 further includes repeating the steps shown in FIGS. 11A-B, only for the temperature instead of the enthalpy. Referring now to FIG. 11C, process 1100 includes determining possible model types based on the temperature data (step 1146). Process 1100 further includes determining if cooling base temperature is feasible (step 1148), setting a range of feasible cooling base temperatures (step 1150), initializing a golden section search (step 1152), iterating the golden section search (step 1154) until a desired base tolerance is reached (step 1156), and determining if the t-statistic is significant (step 1158). Referring now to FIG. 11D, process 1100 includes determining if heating base temperature is feasible (step 1164), setting a range of feasible heating base temperatures (step 1166), initializing a golden section search (step 1168), iterating the golden section search (step 1170) until a desired base tolerance is reached (step 1172), and determining if the t-statistic is significant (step 1174). If the t-statistic is insignificant for either, the cooling or heating base temperature is set to NaN and the minimum sigma for the cooling or heating base temperature is set to infinity (steps 1162, 1178 respectively).

Referring now to FIG. 11E, process 1100 is then configured to recommend a predictor variable based on the base temperatures and minimum sigmas determined in the process. Process 1100 includes recommending a default cooling degree day calculation (step 1184) as a predictor variable if both the cooling base temperature and cooling base enthalpy were both set to NaN in process 1100 (step 1180). Process 1100 may also recommend cooling degree days as a predictor variable if the minimum sigma for cooling energy days is better (e.g., lower) than the minimum sigma for cooling degree days (step 1182). Otherwise, process 1100 recommends using cooling energy days (step 1186).

Process 1100 may repeat steps 1188-1194 for heating degree days and heating energy days. Process 1100 includes recommending a default heating degree day calculation (step 1192) as a predictor variable if both the heating base temperature and heating base enthalpy were both set to NaN in process 1100 (step 1188). Process 1100 may also recommend heating degree days as a predictor variable if the minimum sigma for heating energy days is better than the minimum sigma for heating degree days (step 1190). Otherwise, process 1100 recommends using heating energy days (step 1194).

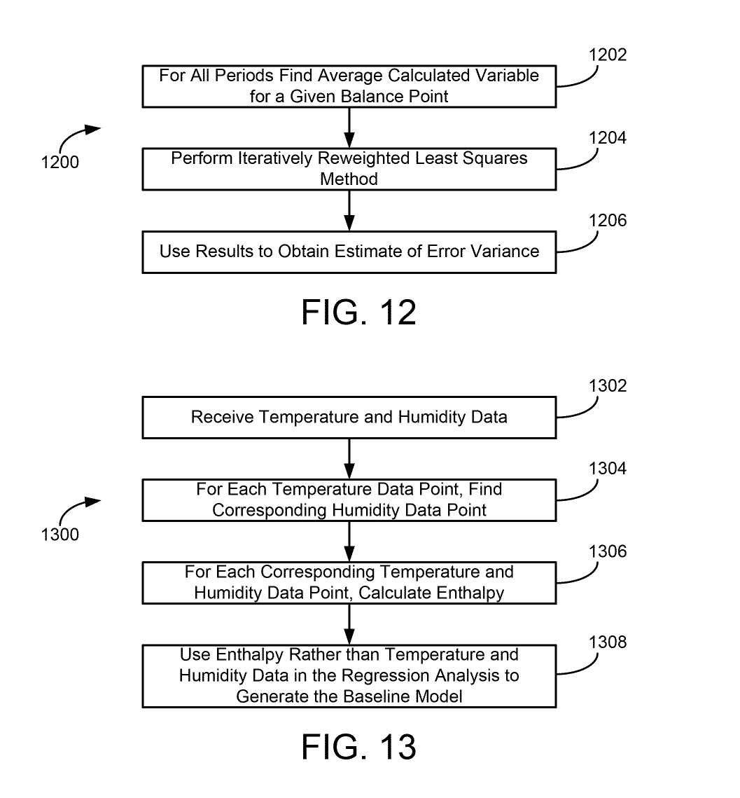

Referring now to FIG. 13, a flow chart of a process 1300 of calculating enthalpy is shown, according to an exemplary embodiment. Process 1300 includes receiving temperature and humidity data (step 1302). Step 1302 may further include identifying and removing humidity data points that are NaN, converting temperature data points to the correct format, or any other pre-processing steps.

Process 1300 further includes, for each temperature data point, finding a corresponding humidity data point (step 1304). For example, for a given time stamp for a temperature data point, step 1304 includes searching for a corresponding time stamp for a humidity data point. According to an exemplary embodiment, a humidity data point with a time stamp within 30 minutes (or another period of time) of the time stamp of the temperature data point may be chosen as a corresponding humidity data point. Step 1304 may further include searching for the closest humidity data point time stamp corresponding with a temperature data point time stamp. If a corresponding humidity data point is not found for a temperature data point, an enthalpy for the time stamp of the temperature data point is not calculated.

Process 1300 further includes, for each corresponding temperature and humidity data point, calculating the enthalpy for the corresponding time stamp (step 1306). The enthalpy calculation may be made via a nonlinear transformation, according to an exemplary embodiment. The calculation includes converting the temperature data into a Rankine measurement and calculating the partial pressure of saturation using the below equation:

$$pws = exp \{ \frac{{C}_{1}}{T} + {C}_{2} + {C}_{3} T + {C}_{4} {T}^{2} + {C}_{5} {T}^{3} + {C}_{6} {T}^{4} + {C}_{7} ln ( t ) \}$$

where C1 through C7 are coefficients and T is the temperature data. The coefficients may be, for example, based on ASHRAE fundamentals. The enthalpy calculation further includes calculating the partial pressure of water using the partial pressure of saturation:

$$pw = \frac{H}{100 * pws}$$

where H is the relative humidity data. The enthalpy calculation further includes calculating the humidity ratio:

$$W = \frac{0.621945 * pw}{p - pw}$$

where W is in terms of pounds water per pound of dry air. The enthalpy calculation further includes the final step of calculating the enthalpy in BTUs per pound dry air:

Enthalpy=0.24*T+W*(1061+0.444*T)

Once the enthalpy is calculated, the enthalpy is used rather than temperature data or humidity data in regression analysis to generate the baseline model (step 1308).

Configurations of Various Exemplary Embodiments

The construction and arrangement of the systems and methods as shown in the various exemplary embodiments are illustrative only. Although only a few embodiments have been described in detail in this disclosure, many modifications are possible. For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on memory or other machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products or memory comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A system for managing costs associated with energy efficient building improvement measures and equipment provided to a building owned by a building owner, comprising:
a building management system in communication with building equipment installed at the building, wherein the building management system is configured to use inputs from the building equipment to estimate the volume and/or peak demand of energy that would have been consumed by the building had the building improvement measures and equipment not been installed; and
a computer system configured to receive a representation of the estimated energy that would have been consumed from the building management system, wherein the computer system is configured to receive a representation of actual energy consumption costs from one or more utility providers for the building;
wherein the computer system is configured to generate an invoice for the building owner based on the estimated energy that would have been consumed by the building had the building improvement measures and equipment not been installed;
wherein the computer system causes payment to an entity financing the building improvement measures and equipment using a portion of the difference between the invoiced estimated energy consumption and the actual energy consumption costs.

2. The system of claim 1, wherein the computer system provides a network-based graphical user interface for displaying a graphical view of the estimated energy that would have been consumed by the building had the building improvement measures and equipment not been installed, and wherein the graphical user interface includes a graphical view of the actual utility consumption over at least the same period of time as the estimated energy that would have been consumed;
wherein the computer system provides control options for allowing the building owner to use the network-based graphical user interface to cause the display or output of at least one of:
(a) calculation details relating to the estimated energy that would have been consumed by the building had the building improvement measures and equipment not been installed,
(b) results of a regression analysis used to build a pre-retrofit baseline model upon which the estimate of the energy that would have been consumed is based, and
(c) exported time data series data for all model inputs and outputs used in estimating the energy that would have been consumed.

3. The system of claim 1, wherein the building management system estimates the energy that would have been consumed by the building had the building improvement measures not been installed by applying the inputs from the building equipment and other data sources to at least one energy consumption model for the building representative of a pre-improvement measures energy consumption model of the building;
wherein the invoice includes an indication of uncertainty relating to the estimate of energy that would have been consumed by the building, wherein the indication of uncertainty is based on a determined uncertainty of the at least one baseline energy consumption model.

4. The system of claim 3, wherein the building management system does not use historical utility costs or historical utility consumption alone to estimate the energy that would have been consumed by the building had the building improvement measures not been installed.

5. The system of claim 4, wherein the building management system uses historical utility consumption to build the at least one utility consumption model.

6. The system of claim 1, wherein the computer system causes payment of service fees to an energy services company that provides services relating to the building improvement measures.

7. A method for managing costs associated with an energy efficient building improvement measure provided to a building owned by a building owner, comprising:
using inputs from the building equipment to estimate energy consumption and/or peak demand that would have been consumed by the building had the building improvement measures not been installed;
generating an invoice for the building owner based on the estimated energy consumption;
receiving a representation of actual energy consumption cost from a utility provider to the building; and
causing payment to an entity financing the building improvement measure using a portion of the difference between the invoiced utility consumption and the actual energy consumption cost.

8. The method of claim 7, wherein a building management system estimates the energy that would have been consumed by the building by applying the inputs from the building equipment to an energy consumption model representative of how the building consumed energy prior to installation of the energy efficient building improvement measure.

9. The method of claim 8, wherein the building management system does not use historical utility costs or historical utility consumption alone to estimate the energy that would have been consumed by the building had the building improvement measures not been installed.

10. The method of claim 9, wherein the building management system uses historical utility consumption to build the at least one energy consumption model.

11. The method of claim 7, further comprising:
causing payment of service fees to an energy services company that provides services relating to the energy efficient building improvement measure.

12. A computerized method for managing costs associated with energy efficient building improvement measures provided to a building owned by a building owner, comprising:
receiving an invoice for actual energy consumption by the building from an energy provider;
receiving data from building equipment and using the data to generate an invoice based on an estimated energy that would have been consumed by the building had the building improvement measures not been installed; and
causing payment to an entity financing the building improvement measures using a portion of the difference between the invoiced estimated energy consumption and the actual energy consumption costs.

13. The method of claim 12, further comprising:
using a building management system in communication with the building equipment to calculate the estimated energy that would have been consumed by the building had the building improvement measures not been installed;
wherein the building management system calculates the estimated energy by applying inputs from the building equipment and from other data sources to at least one energy consumption model representative of how the building consumed energy prior to the installation of the energy efficient measures.

14. The method of claim 13, wherein the building management system does not use historical utility costs or historical utility consumption alone to estimate the energy that would have been consumed by the building had the building improvement measures not been installed.

15. The method of claim 14, wherein the building management system uses historical utility consumption to build the at least one energy consumption model.

16. The method of claim 12, further comprising:
causing payment of service fees to an energy services company or another vendor that provides maintenance services relating to the building improvement measures.

17. The method of claim 12, wherein the building improvement measures are provided to the building as a part of a service contract.

18. The method of claim 12, wherein the building improvement measures are provided to the building as a part of a service contract between an ownership company and the building owner.

19. The method of claim 18, wherein the ownership company pays the invoice for the actual energy consumption as an agent of the building owner; and
wherein the method further comprises:
causing payment to an energy services company using a portion of the difference between the invoiced estimated energy consumption and the actual energy consumption costs.

20. Computer readable media having computer code instructions for execution by a processor, the computer code instructions for managing costs associated with energy efficient building improvement measures provided to a building owned by a building owner, the computer code instructions comprising:
computer code instructions for receiving an invoice for actual energy consumption by the building from an energy provider;
computer code instructions for receiving data from the building equipment and using the data to generate an invoice based on an estimated energy that would have been consumed by the building had the building improvement measures had not been installed; and
computer code instructions for causing payment to an entity financing the building improvement measures using a portion of the difference between the invoiced estimated energy consumption and the actual energy consumption costs.
